(19) United States
(12) Patent Application Publication
(10) Pub. No.: US 2014/0198231 A1
(43) Pub. Date: Jul. 17, 2014

(54) IMAGE PROCESSING APPARATUS, IMAGE PICKUP APPARATUS AND IMAGE PROCESSING METHOD

(71) Applicant: Canon Kabushiki Kaisha, Tokyo (JP)

(72) Inventor: Yoshinori Itoh, Shimotsuke-shi (JP)

(73) Assignee: Canon Kabushiki Kaisha, Tokyo (JP)

(21) Appl. No.: 14/153,323

(22) Filed: Jan. 13, 2014

(30) Foreign Application Priority Data
Jan. 15, 2013 (JP) 2013-004355

(51) Int. Cl. H04N 5/232

(52) U.S. Cl. CPC H04N 5/23229
USPC 348/222.1

(57) ABSTRACT

The image processing apparatus includes an image acquirer configured to acquire an input image produced by image capturing through a zoom lens whose magnification is variable, and a processor configured to perform an image restoration process using an image restoration filter produced on a basis of information on aberration of the zoom lens. The processor is configured to not perform the image restoration process on a central image area of the input image produced by the image capturing through the zoom lens set in a specific magnification state and to perform the image restoration process on a specific image area more outer than the central image area of that input image.

### BACKGROUND OF THE INVENTION

1. Field of the Invention

The present invention relates to an image processing technology to perform an image restoration process on an image generated by image capturing using a zoom lens.

2. Description of the Related Art

An image acquired by image capturing of an object by an image pickup apparatus such as a digital camera contains a blur component that is an image degradation component caused by spherical aberration, coma aberration, field curvature, astigmatism or the like of an image pickup optical system (hereinafter simply referred to as “an optical system”).

Such a blur component is generated because a light flux emitted from one point of the object forms an image with some divergence on an image pickup plane; the light flux should normally converge at one point when there is no influence of aberration or diffraction.

Such a blur component is optically expressed by a point spread function (PSF), which is different from a blur caused by defocus.

Moreover, a color blur in a color image caused by longitudinal chromatic aberration, chromatic spherical aberration or chromatic coma aberration of the optical system can be said to be a difference between blurring degrees of respective wavelengths of light.

In addition, horizontal color shift caused by chromatic aberration of magnification of the optical system can be said to be position shift or phase shift of color light components caused by differences of image capturing magnifications for the respective color light components.

An optical transfer function (OTF) obtained by Fourier transform of the point spread function (PSF) is frequency component information of aberration, which is expressed by a complex number.

An absolute value of the optical transfer function (OTF), that is, an amplitude component is called a modulation transfer function (MTF), and a phase component is called a phase transfer function (PTF).

The MTF and the PTF are respectively a frequency characteristic of the amplitude component and a frequency characteristic of the phase component of image degradation caused by the aberration.

The phase component is herein expressed as a phase angle by the following expression where Re(OTF) and Im(OTF) respectively represent a real part and an imaginary part of the OTF.

Re (OTF) and Im (OTF) express the real part and imaginary part of OTF, respectively.

PTF=tan⁻¹(Im(OTF)/Re(OTF))

Thus, since the optical transfer function (OTF) of the optical system degrades the amplitude component and the phase component of the image, respective points of the object in the degraded image are asymmetrically blurred like coma aberration.

Moreover, the chromatic aberration of magnification is generated because an image pickup apparatus captures, according to its spectral characteristics, images of respective color components whose imaging positions are mutually shifted due to differences of imaging magnifications for respective light wavelengths.

Therefore, not only the shift of the imaging positions among the color components is generated, but also shift of imaging positions among wavelengths in each color component, that is, the phase shift is generated, which causes image spread.

Thus, although the chromatic aberration of magnification is strictly not a color shift as a mere parallel shift, this specification describes the color shift as being the same as the chromatic aberration of magnification.

As a method for correcting the degradation of the amplitude component (MTF) and the degradation of the phase component (PTF) in the degraded image (input image), there is known one using information on the optical transfer function (OTF) of the optical system.

This method is called “image restoration” or “image recovery”, and a process to correct the degraded image (to reduce the blur component) by using the information of the optical transfer function (OTF) of the optical system is hereinafter referred to as “an image restoration process” or simply as “image restoration”. As a method of the image restoration, though described in detail below, there is known one which performs convolution of an image restoration filter in a real space on the input image; the image restoration filter has an inverse characteristic to that of the optical transfer function.

Japanese translation of a PCT application publication No. 2005-509333 discloses an image processing method which holds filter coefficients to be used for correction of image degradation due to aberration of an image capturing optical system and performs the image restoration (image recovery) using the filter coefficients.

This disclosed method performs the image restoration to allow the aberration of the image capturing optical system, which enables miniaturization of the image capturing optical system and increase of an aperture diameter thereof.

In addition, the disclosed method corrects, by the image restoration, the image degradation generated due to increase of refractive indices of lens units constituting the image capturing optical system, which enables increase of magnification of a compact image capturing optical system.

However, performing the image restoration on all images obtained in the entire magnification variation range of the image capturing optical system extremely increases a data amount of the filter coefficients.

Moreover, the increase of the data amount of the filter coefficients decreases an image processing speed and increases manufacturing cost because of necessity of an image processing engine capable of performing high-speed computing.

On the other hand, allowing an excessively large aberration makes it impossible to correct, by the image restoration, the degradation component due to the aberration and increases noise resulted from increase of a degree of the image restoration.

Accordingly, even in the case of performing the image restoration, it is necessary to take into consideration an amount of the aberration of the image capturing optical system appropriate for the image restoration.

For example, of various aberrations of the image capturing optical system, a large field curvature makes “uneven blur” remarkable; the uneven blur is generated by asymmetry of resolution caused by tilting of an image plane on an image sensor due to manufacturing errors of lenses or tilting of the image sensor.

Such uneven blur makes it difficult to perform good image restoration difficult.

The image processing method disclosed in Japanese translation of a PCT application publication No. 2005-509333 does not take into consideration the aberration amount appropriate for the image restoration and further does not take into consideration the aberration amount appropriate for suppressing the data amount.

### SUMMARY OF THE INVENTION

The present invention provides an image processing apparatus, an image pickup apparatus, an image processing program and an image processing method each capable of fast performing good image restoration while achieving miniaturization of an image capturing optical system and increase of an aperture diameter thereof.

The present invention provides as one aspect thereof an image processing apparatus including an image acquirer configured to acquire an input image produced by image capturing through a zoom lens whose magnification is variable, and a processor configured to perform an image restoration process using an image restoration filter produced on a basis of information on aberration of the zoom lens. The processor is configured to not perform the image restoration process on a central image area of the input image produced by the image capturing through the zoom lens set in a specific magnification state and to perform the image restoration process on a specific image area more outer than the central image area of that input image.

The present invention provides as another aspect thereof an image pickup apparatus including an image capturer configured to perform image capturing using a zoom lens, and the above-described image processing apparatus.

The present invention provides as still another aspect thereof a non-transitory storage medium storing an image processing program to cause a computer to perform a process on an input image produced by image capturing through a zoom lens whose magnification is variable. The process includes acquiring the input image, and performing an image restoration process using an image restoration filter produced on a basis of information on aberration of the zoom lens. The process does not perform the image restoration process on a central image area of the input image produced by the image capturing through the zoom lens set in a specific magnification state and performs the image restoration process on a specific image area more outer than the central image area of that input image.

The present invention provides as yet still another aspect thereof an image processing method including acquiring an input image, and performing an image restoration process using an image restoration filter produced on a basis of information on aberration of the zoom lens. The method does not perform the image restoration process on a central image area of the input image produced by the image capturing through the zoom lens set in a specific magnification state and performs the image restoration process on a specific image area more outer than the central image area of that input image.

Further features of the present invention will become apparent from the following description of exemplary embodiments (with reference to the attached drawings).

### BRIEF DESCRIPTION OF THE DRAWINGS

FIGS. 1A to 1C are sectional views of a zoom lens used in an image pickup apparatus that is Embodiment 1 of the present invention.

FIGS. 2A to 2C are sectional views of another zoom lens used in the image pickup apparatus of Embodiment 1.

FIGS. 3A to 3C are sectional views of still another zoom lens used in the image pickup apparatus of Embodiment 1.

FIGS. 4A and 4B respectively show longitudinal aberration charts and lateral aberration charts of the zoom lens shown in FIGS. 1A to 1C at its wide-angle end.

FIGS. 5A and 5B respectively show longitudinal aberration charts and lateral aberration charts of the zoom lens shown in FIGS. 1A to 1C at its middle zoom position.

FIGS. 6A and 6B respectively show longitudinal aberration charts and lateral aberration charts of the zoom lens shown in FIGS. 1A to 1C at its telephoto end.

FIGS. 7A and 7B respectively show longitudinal aberration charts and lateral aberration charts of the zoom lens shown in FIGS. 2A to 2C at its wide-angle end.

FIGS. 8A and 8B respectively show longitudinal aberration charts and lateral aberration charts of the zoom lens shown in FIGS. 2A to 2C at its middle zoom position.

FIGS. 9A and 9B respectively show longitudinal aberration charts and lateral aberration charts of the zoom lens shown in FIGS. 2A to 2C at its telephoto end.

FIGS. 10A and 10B respectively show longitudinal aberration charts and lateral aberration charts of the zoom lens shown in FIGS. 3A to 3C at its wide-angle end.

FIGS. 11A and 11B respectively show longitudinal aberration charts and lateral aberration charts of the zoom lens shown in FIGS. 3A to 3C at its middle zoom position.

FIGS. 12A and 12B respectively show longitudinal aberration charts and lateral aberration charts of the zoom lens shown in FIGS. 3A to 3C at its telephoto end.

FIGS. 13A and 13B show an image restoration filter used in the image pickup apparatus of Embodiment 1.

FIGS. 14A and 14B show correction of a point image by an image restoration process performed in the image pickup apparatus of Embodiment 1.

FIGS. 15A and 15B show correction of an amplitude component and a phase component by the image restoration process.

FIGS. 16A to 16C show examples of an area of an input image on which the image restoration process is performed in the image pickup apparatus of Embodiment 1.

FIG. 17 shows a configuration of the image pickup apparatus of Embodiment 1.

FIG. 18 is a flowchart showing image processing (including the image restoration process) performed in the image pickup apparatus of Embodiment 1.

FIG. 19 shows a configuration of an image processing apparatus that is Embodiment 2 of the present invention.

### DETAILED DESCRIPTION OF THE EMBODIMENTS

Exemplary embodiments of the present invention will be described below with reference to the accompanied drawings.

First of all, prior to description of specific embodiments, description will be made of definition of terms to be used in the embodiments and an image restoration process performed in the embodiments.

### “Input Image”

The input image is a digital image produced by using an image pickup signal obtained by photoelectric conversion of an object image by an image sensor (image pickup element) such as a CCD sensor or a CMOS sensor; the object image is formed by an image capturing optical system provided to an image pickup apparatus such as a digital still camera or a video camera.

The digital image as the input image is degraded due to an optical transfer function (OTF) of the image capturing optical system constituted by optical elements such as lenses and various optical filters; the optical transfer function including information on aberration of the image capturing optical system. The optical system may include a mirror (reflective surface) having a curvature.

The image capturing optical system may be detachably attachable (interchangeable) to the image pickup apparatus.

In the image pickup apparatus, the image sensor and a signal processor producing digital images (input images) by using output from the image sensor constitute an image pick-up system (image capturer).

The input image has information on color components such as RGB components.

The color components can be also expressed by, other than the RGB, a selected one of general color spaces such as LCH (lightness, chroma and hue), YCbCr, color difference signal, XYZ, Lab, Yuv and JCh, or can be expressed by color temperature.

Moreover, the input image and a restored image (output image described later) can be provided with information on an image pickup condition (state), in other words, image pickup condition information including a focal length of the image capturing optical system, an aperture value (F-number) thereof, an image pickup distance (object distance) and the like. In addition, the input image and the restored image can be provided with various correction information to be used for correction of the input image. When an image processing apparatus, which is separately provided from the image pickup apparatus, performs an image restoration process (described later) on the input image received from the image pickup apparatus, it is desirable to add the image pickup condition information and the correction information to the input image.

The image pickup condition information and the correction information can be sent, other than being added to the input image, from the image pickup apparatus through direct or indirect communication.

### “Image Restoration Process”

When g(x,y) represents an input image (degraded image) produced through image capturing performed by an image pickup apparatus, f(x,y) represents a non-degraded original image, h(x,y) represents a point spread function (PSF) that forms a Fourier pair with the optical transfer function (OTF), * represents convolution, and (x,y) represents coordinates (position) on the image, the following expression is established:

g(x,y)=h(x,y)*f(x,y).

Converting the above expression into a form of a two-dimensional frequency surface through Fourier transform provides the following expression of a form of a product for each frequency:

G(u,v)=H(u,v)·F(u,v)

where H represents a result of Fourier transform of the point spread function (PSF), in other words, the optical transfer function (OTF), G and F respectively represent results of Fourier transform of g and h, and (u,v) represents coordinates on the two-dimensional frequency surface, in other words, a frequency.

Dividing both sides of the above expression by H as below provides the original image from the degraded image:

G(u,v)/H(u,v)=F(u,v).

Returning F(u,v), that is, G (u,v)/H (u,v) by inverse Fourier transform to a real surface provides a restored image equivalent to the original image f(x, y).

When R represents a result of inverse Fourier transform of H⁻¹, performing a convolution process for an image in the real surface as represented by the following expression also enables provision of the original image:

g(x,y)*R(x,y)=f(x,y).

This R(x,y) in the above expression is an image restoration filter. When the image is a two-dimensional image, the image restoration filter is generally also a two-dimensional filter having taps (cells) corresponding to pixels of the two-dimensional image.

Moreover, increase of the number of the taps (cells) in the image restoration filter generally improves image restoration accuracy, so that a realizable number of the taps is set depending on requested image quality, image processing capability, aberration characteristics of the image capturing optical system and the like.

Since the image restoration filter needs to reflect at least the aberration characteristics, the image restoration filter is different from a conventional edge enhancement filter (high-pass filter) having about three taps in each of horizontal and vertical directions.

Since the image restoration filter is produced based on the optical transfer function (OTF) including information on the aberration of the image capturing optical system, degradation of amplitude and phase components can be highly accurately corrected.

Since a real image includes a noise component, using an image restoration filter produced from the complete inverse number of the optical transfer function (OTF) as described above amplifies the noise component together with the restoration of the degraded image.

This is because the image restoration filter raises an MTF (modulation transfer function) of the optical system, which corresponds to the amplitude component of the image, to 1 over an entire frequency range in a state where amplitude of the noise component is added to the amplitude component of the image. Although the MTF (amplitude component) degraded by the image capturing optical system is returned to 1, power spectrum of the noise component is simultaneously raised, which results in amplification of the noise component in accordance with a degree of raising of the MTF, that is, a restoration gain.

Therefore, the noise component makes it impossible to provide a good image for appreciation. Such raising of the noise component is shown by the following expressions where N represents the noise component:

G(u,v)=H(u,v)·F(u,v)+N(u,v)

G(u,v)/H(u,v)=F(u,v)+N(u,v)/H(u,v)

As a method for solving such a problem, there is known, for example, a Wiener filter represented by the following expression (1), which suppresses the restoration gain on a high frequency side of the image according to an intensity ratio (SNR) of an image signal and a noise signal.

$$M ( u , v ) = \frac{1}{H ( u , v )} \frac{{\vert H ( u , v ) \vert}^{2}}{{\vert H ( u , v ) \vert}^{2} + {SNR}^{2}} \qquad ( 1 )$$

In expression (1), M(u,v) represents a frequency characteristic of the Wiener filter, and |H(u,v)| represents an absolute value (MTF) of the optical transfer function (OTF).

This method decreases the restoration gain as the MTF is lower, in other words, increases the restoration gain as the MTF is higher. The MTF of the image capturing optical system is generally high on a low frequency side range and low on a high frequency side range, so that the method resultantly suppresses the restoration gain on the high frequency side range of the image.

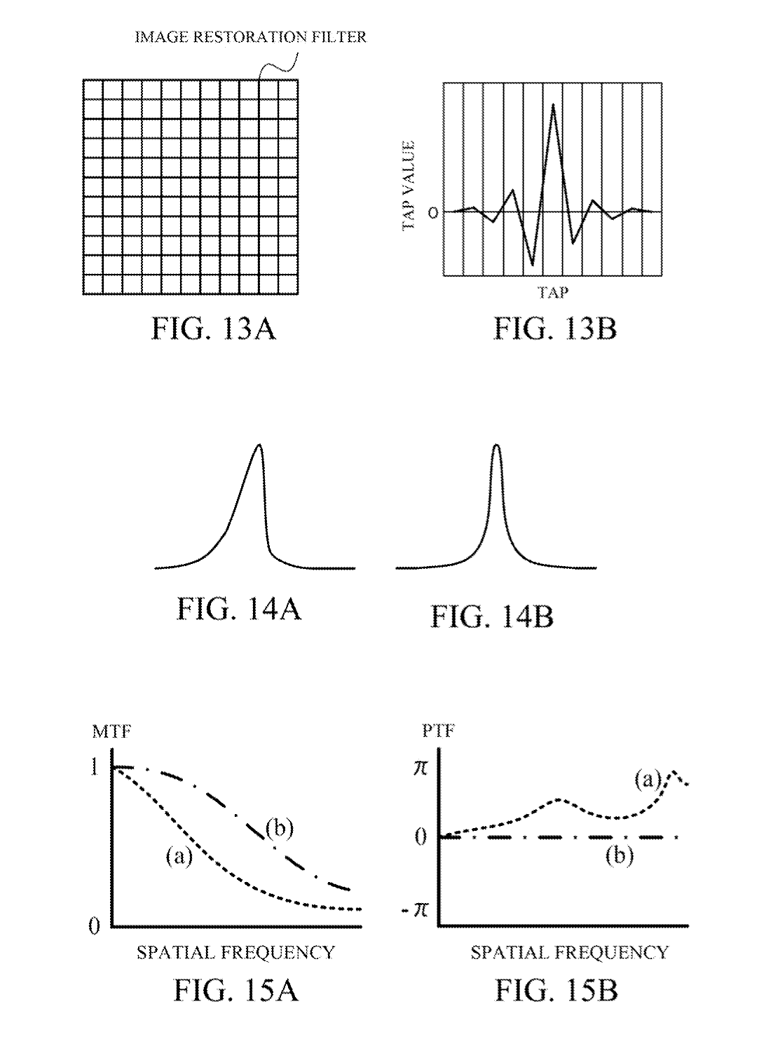

An example of the image restoration filter is shown in FIG. 13A. For the image restoration filter, the number of the taps (cells) is decided depending on aberration characteristics of the image capturing optical system and demanded restoration accuracy. The image restoration filter shown in FIG. 13A is a two-dimensional filter having 11×11 cells.

Although FIG. 13A omits values in the respective taps, FIG. 13B shows a sectional plane of this image restoration filter. The values in the respective taps of the image restoration filter shown in FIG. 13B are set on the basis of various aberration information of the image capturing optical system.

The distribution of the values (coefficient values) of the respective taps of the image restoration filter plays a role to return signal values (PSF) spatially spread due to the aberration to, ideally, one point.

In the image restoration process (hereinafter also simply referred to as “image restoration”), convolution of each tap of the image restoration filter is performed on each corresponding pixel of the input image.

In such a convolution process, in order to improve the signal value of a certain pixel in the degraded image, that pixel is matched to a center tap of the image restoration filter.

Then, a product of the signal value of the input image and the tap value of the image restoration filter is calculated for each corresponding pair of the pixel of the input image and the tap of the filter, and the signal value of the pixel corresponding to the center tap of the filter is replaced by a total sum of the products.

Characteristics of the image restoration in a real space and a frequency space will be described with reference to FIGS. 14A, 14B, 15A and 15B.

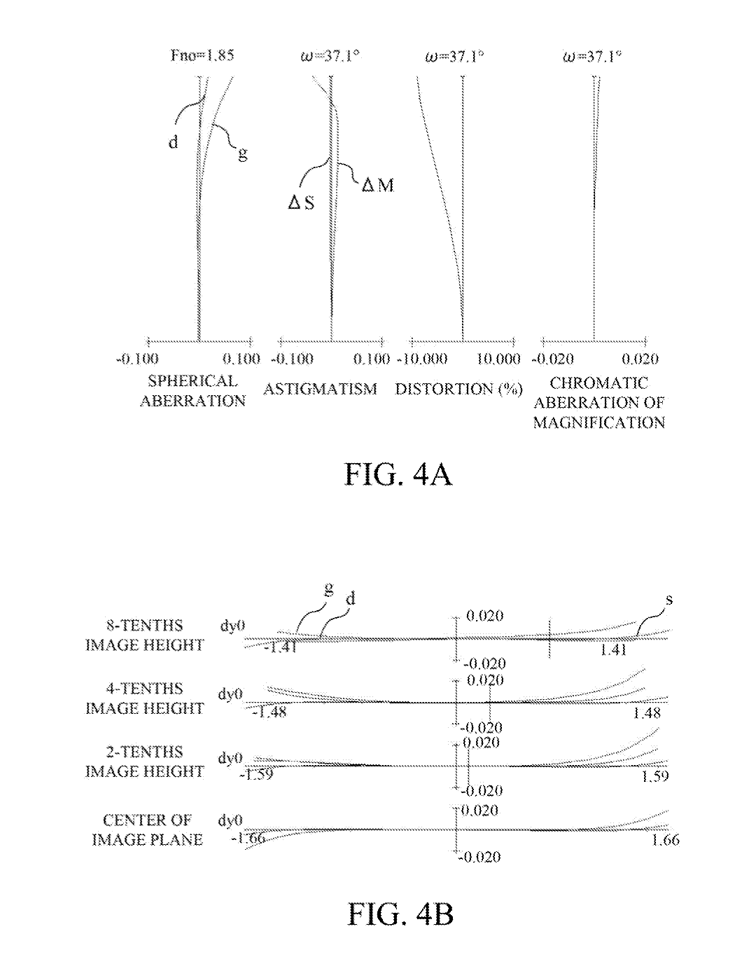

FIG. 14A shows a PSF (point spread function) before the image restoration, and FIG. 4B shows a PSF after the image restoration.

FIG. 15A shows (a) an MTF before the image restoration and (b) an MTF after the image restoration. FIG. 15B shows (a) a PTF (phase transfer function) before the image restoration and (b) a PTF after the image restoration.

The PSF before the image restoration asymmetrically spreads, and the PTF is non-linear due to the asymmetry.

The image restoration process amplifies the MTF and corrects the PTF to zero, so that the PSF after the image restoration becomes symmetric and sharp.

This image restoration filter can be produced by inverse Fourier transform of a function designed on the basis of an inverse function of the optical transfer function (OTF) of the image capturing optical system.

For example, in a case of using the Wiener filter, the image restoration filter can be produced by inverse Fourier transform of expression (1).

The optical transfer function (OTF) varies depending on image heights (positions in the input image) even under the same image pickup condition. Therefore, the image restoration filter to be used is changed corresponding to the image height.

Next, description will be made of specific embodiments of the present invention.

When image capturing is performed using a zoom lens that is an image capturing optical system whose magnification is variable, that is, which is capable of zooming, the image restoration is generally performed over the entire zoom range and on the entire input image.

However, such image restoration requires a huge amount of data of the image restoration filters and a long calculation time in the image restoration process.

Thus, in order to reduce the data amount and to accelerate the image restoration process, each embodiment of the present invention limits a zoom range (magnification state) and an image area where the image restoration is performed.

Specifically, a processor (as an image restorer, described later) in each embodiment does not perform the image restoration process on a central image area of an input image (specific zoomed input image) produced by image capturing through the zoom lens set in a specific zoom range, such as a wide-angle end and a telephoto end, of the entire zoom range and performs the image restoration process on a specific image area more outer than the central image area of the specific zoomed input image.

In the following description, the specific image area more outer than the central image area is referred to as “a specific peripheral image area.”

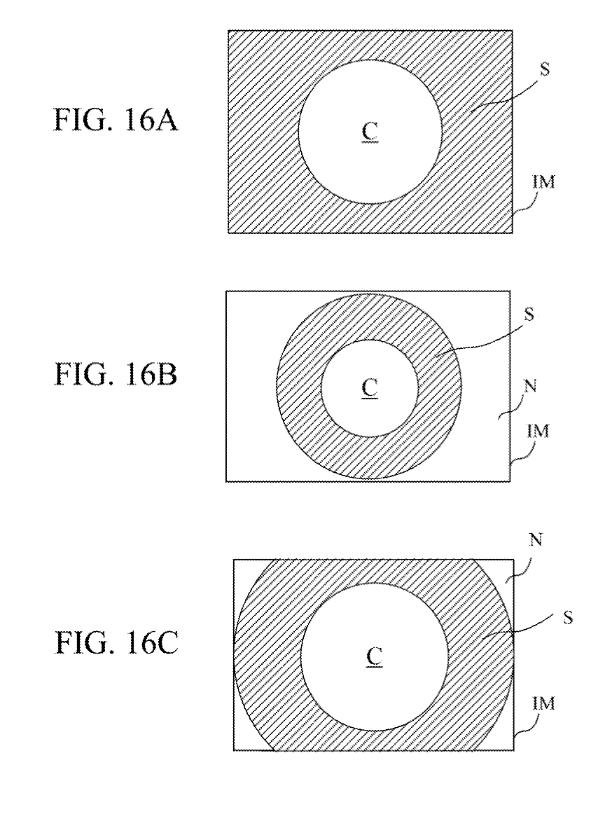

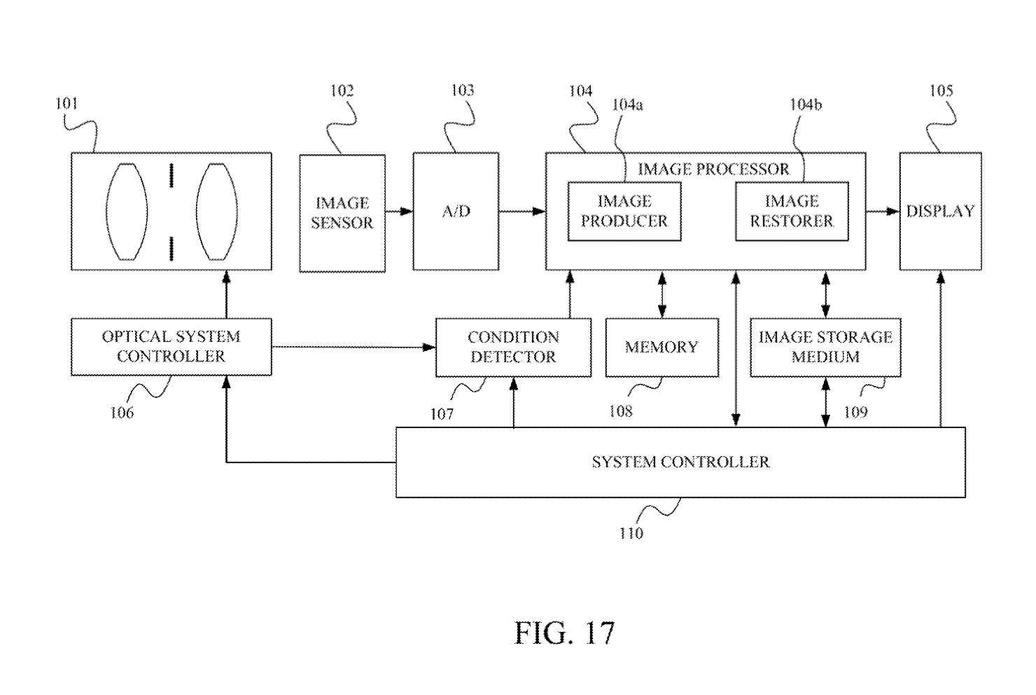

FIGS. 16A to 16C show examples of the central image areas (each shown as a white area) C where the image restoration is not performed and the specific peripheral image areas (each shown as a hatched area) S where the image restoration is performed.

In FIG. 16A, of the specific zoomed input image IM, an entire area other than the central image area C is the specific peripheral image area S.

In FIG. 16B, of the entire area other than the central image area C in the specific zoomed input image IM, a partial ring (toric) area near the central image area C (other than a more outer area N) is the specific peripheral image area S. Moreover, in FIG. 16C, of the entire area other than the central image area C in the specific zoomed input image IM, an area other than four outermost areas N is the specific peripheral image area S.

Performing the image restoration (partial image restoration) only on the specific peripheral image area S as described above makes it possible to omit image restoration filters to be applied for the central image area C and the image area(s) N more outer than the specific peripheral image area S.

Thereby, each embodiment can reduce the data amount necessary for the image restoration and accelerate the image restoration process.

Next, description of more specific embodiments will be made.

### Embodiment 1

In FIG. 17, a light flux from an object (not shown) passing through an image capturing optical system 101 forms an object image on an image sensor 102 constituted by a CCD sensor or a CMOS sensor.

The image capturing optical system 101 is constituted by a zoom lens described later.

The object image formed on the image sensor 102 is converted by the image sensor 102 into an analog electric signal.

The analog electric signal output from the image sensor 102 is converted into a digital image pickup signal by an A/D converter 103, and the digital image pickup signal is input to an image processor 104.

The image processor 104 is constituted by an image processing computer and includes an image producer 104a that performs various processes on the input digital image pickup signal to produce a color input image. The image sensor 102 and the image producer 104a constitute an image capturer.

Moreover, the image processor 104 includes an image restorer 104b that performs the image restoration process on the input image. The image restorer 104b acquires information showing a condition (hereinafter referred to as “an image pickup condition) of the image capturing optical system 101, that is, image pickup condition information from a condition detector 107.

The image pickup condition includes a focal length (zoom position), an aperture value (F-number) and an object distance (at which an in-focus state is obtained) of the image capturing optical system 101. The condition detector 107 may acquire the image pickup condition from a system controller 110 or an optical system controller 106 that controls the image capturing optical system 101.

Moreover, the image pickup condition is enough to include at least one of the focal length, the aperture value and the in-focus object distance, and may include other parameters.

A memory 108 stores (saves) the image restoration filters corresponding to limited ones of the image pickup conditions (combinations of the various zoom positions, aperture values and object distances).

The image restorer 104b acquires (selects) the image restoration filter corresponding to the actual image pickup condition from the memory 108 and performs the image restoration on the input image by using the acquired image restoration filter.

The image restoration may restore only the phase component, and may slightly change the amplitude component when noise amplification is within an allowable range.

Furthermore, the image processor 104 includes at least a calculator and a temporary memory (buffer) and performs writing and reading (storing) of images to and from the temporary memory at every process described later as needed.

As the memory 108, a temporary memory may be used.

Alternatively, the memory 108 may store (save) filter coefficients necessary to produce the image restoration filters corresponding to the above-mentioned limited image pickup conditions and produce the image restoration filter to be used by using the stored filter coefficient.

Such a case that the filter coefficients to be used to produce the image restoration filters are stored in the memory 108 is equivalent to the case that the image restoration filters are stored in the memory 108.

Moreover, selecting the filter coefficient corresponding to the image pickup condition and producing the image restoration by using the selected filter coefficient is also equivalent to acquiring the image restoration filter.

The condition detector 107, the image restorer 104b and the memory 108 constitute an image processing apparatus in the image pickup apparatus.

The image restorer 104b serves as an image acquirer and a processor. The image restorer 104b serves as an image condition acquirer together with the condition detector 107.

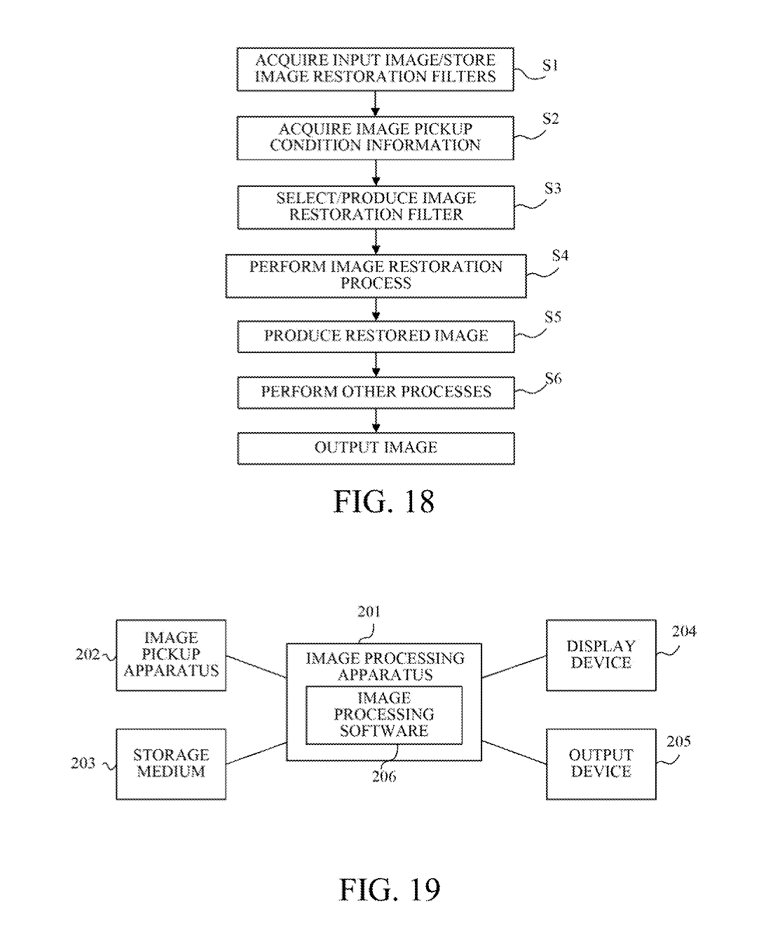

FIG. 18 is a flowchart showing a procedure of the image restoration process (image processing method) performed by the image restorer 104b; the image restorer 104b is hereinafter referred to as the image processor 104.

The image processor 104 is constituted by the image processing computer, as described above, and executes the following processes according to an image processing program as a computer program.

At step S1, the image processor 104 acquires (provides) the input image that is an image produced on the basis of the output signal from the image sensor 102.

Moreover, the image processor 104 stores, before or after the acquisition of the input image, the image restoration filter to be used for the image restoration process to the memory 108.

Next, at step S2, the image processor 104 acquires the image pickup condition information from the condition detector 107.

In this description, the image pickup condition includes three parameters, that is, the zoom position, the aperture value and the object distance.

Next, at step S3, the image processor 104 selects (acquires), from the image restoration filters stored in the memory 108, the image restoration filter corresponding to the image pickup condition acquired at Step S2.

Alternatively, when the filter coefficients are stored in the memory 108 as described above, the image processor 104 selects the filter coefficients corresponding to the image pickup condition and substantially acquires the image restoration filter by producing it by using the selected filter coefficients.

Next, at step S4 (processing step), the image processor 104 performs, on the input image acquired at Step S1, the image restoration using the image restoration filter acquired at Step S3.

Then, at step S5, the image processor 104 produces a restored image resulted by the image restoration.

Next, at step S6, the image processor 104 performs, on the restored image, other image processes than the image restoration to acquire a final output image.

The other image processes than the image restoration include, if the restored image is a mosaic image, a color interpolation process (demosaicing process). Moreover, the other processes than the image restoration include an edge enhancement process, a shading compensation (peripheral light amount compensation), a distortion correction and the like. These other image process than the image restoration may be performed not only after the image restoration but also before and in the middle of the image restoration.

### Embodiment 2

Although Embodiment 1 described the image pickup apparatus provided with the image processing apparatus that performs the image restoration process, a personal computer in which an image processing program is installed can also perform the image restoration process.

In FIG. 19, a personal computer 201 as an image processing apparatus includes an image processing software (image processing program) 206 installed therein.

As an image pickup apparatus 202, various apparatuses can be used which have an image pickup function, such as not only a common digital camera and a common video camera, but also a microscope, an endoscope and a scanner.

The image pickup apparatus 202 performs image capturing using any one of zoom lenses described later as an image capturing optical system.

A storage medium 203 is an outside memory such as a semiconductor memory, a hard disk and a sever on a network, which stores data of images produced through image capturing by the image pickup apparatus 202 or other image pickup apparatuses.

The storage medium 203 may store data of the image restoration filters.

The image processing apparatus 201 acquires an image (input image) from the image pickup apparatus 202 or the storage medium 203 and performs various image processes including the image restoration process described in Embodiment 1 to produce an output image.

The image processing apparatus 201 may acquire the image restoration filter from an inside memory provided thereinside or from the outside storage medium 203. Moreover, the image processing apparatus 201 outputs data of the output image to at least one of an output apparatus 205 such as a printer, the image pickup apparatus 202 and the storage medium 203, or saves it in the inside memory.

The image processing apparatus 201 is connected to a display device (monitor) 204. A user can perform, through the display device 204, an image processing operation and evaluate the output image.

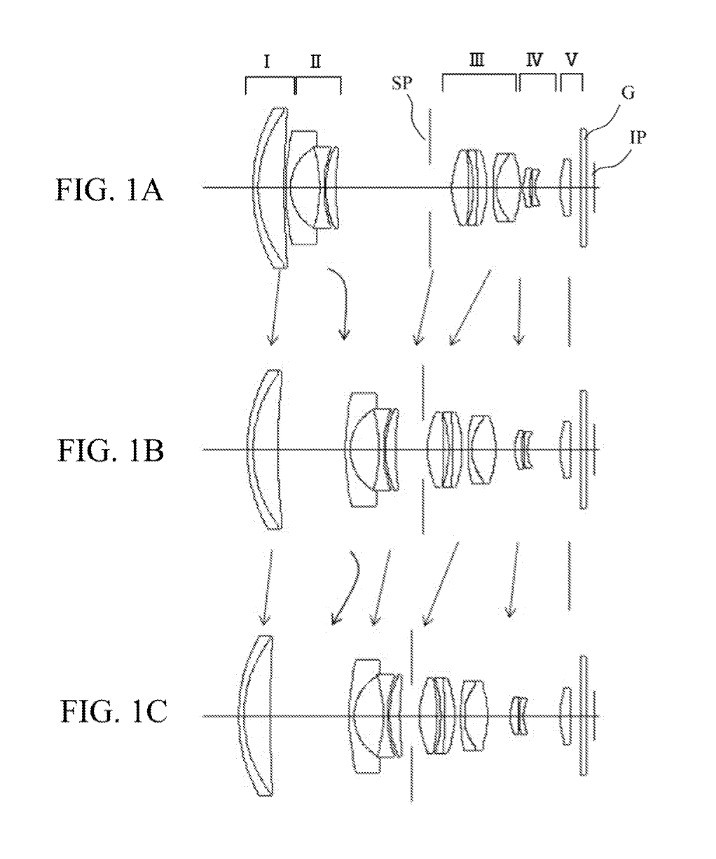

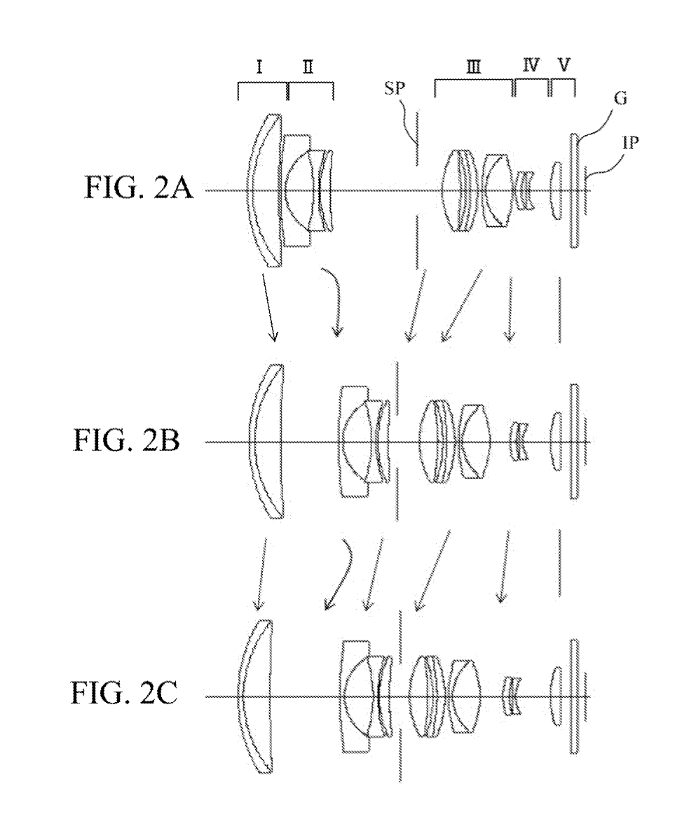

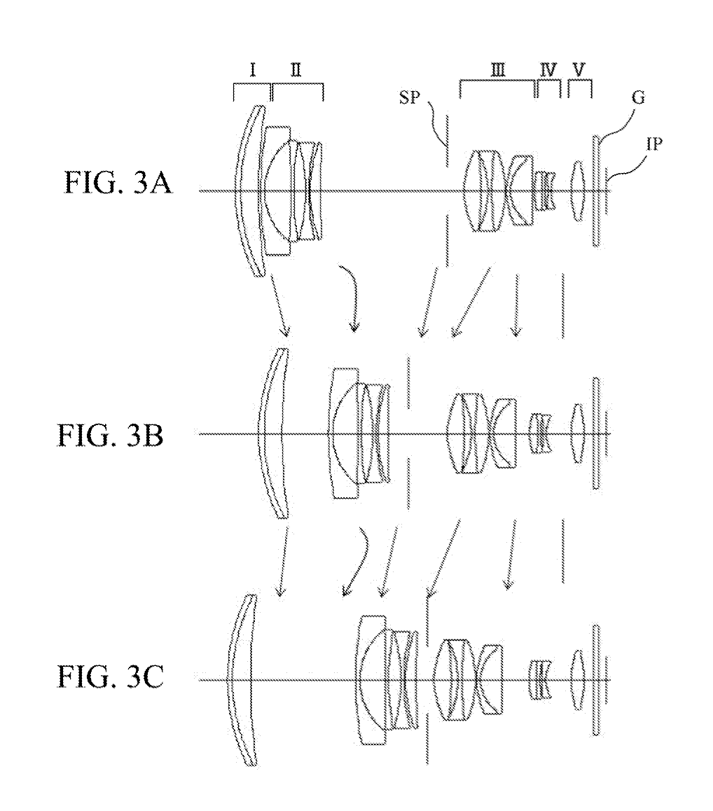

Next, description will be made of examples of the zoom lens used as the image capturing optical system 101 in the image pickup apparatus shown in FIG. 17 and in the image pickup apparatus 202 shown in FIG. 19, with reference to FIGS. 1A to 1C (hereinafter abbreviated as FIG. 1), FIGS. 2A to 2C (hereinafter abbreviated as FIG. 2) and FIGS. 3A to 3C (hereinafter abbreviated as FIG. 3).

The zoom lenses shown in FIGS. 1 to 3 are each constituted by, in order from an object side to an image side, a positive first lens unit I, a negative second lens unit II, a positive third lens unit III, a negative fourth lens unit IV and a positive fifth lens unit V. SP denotes an aperture stop, G denotes an optical block such as an optical filter, and IP denotes an image plane.

In these zoom lenses, during zooming from a wide-angle end (shown in FIGS. 1A, 2A and 3A) to a telephoto end (shown in FIGS. 1C, 2C and 3C) via a middle zoom position (shown in FIGS. 1B, 2B and 3B), the first lens unit I is moved monotonously to the object side as shown in FIG. 1 or is moved once to the image side and then moved to the object side as shown in FIGS. 2 and 3.

Moreover, the first lens unit I is located, at the telephoto end, on the object side further than at the wide-angle end.

The second lens unit II is moved once to the image side and then moved to the object side. The third lens unit III is moved monotonously to the object side.

The aperture stop disposed between the second lens unit II and the third lens unit III is moved monotonously to the object side.

The fourth lens unit IV is moved minutely with respect to the image plane IP.

The fifth lens unit V is not moved (is fixed) with respect to the image plane IP during the above-mentioned zooming.

Each of the zoom lenses shown in FIGS. 1 to 3 has a magnification ratio of approximately 3.6×, and is constituted as an optical system having a small F-number (Fno) over the entire zoom range from the wide-angle end to the telephoto end.

Each of the zoom lenses shown in FIG. 1 and is a zoom lens designed on an assumption that the image restoration process is performed to correct an image degradation component (aberration ingredient) due to coma aberration in a wide-angle range. When the zoom lens having a magnification ratio of approximately 3.6× including the wide-angle range is provided with a large aperture diameter of approximately F1.7 to F2.0, in the third lens unit III as a main magnification-varying lens unit, areas through which light rays pass at respective zoom positions over the entire zoom range overlap one another.

In such a zoom lens, variation of field curvature, which is difficult to be corrected by the image restoration, is likely to increase.

Therefore, each of the zoom lenses shown in FIGS. 1 and 3 is designed so that the coma aberration generated in a peripheral side area of the image plane IP in the wide-angle range is allowed to a certain degree and thereby the variation of the field curvature in a middle zoom range is suppressed.

On the other hand, each of the zoom lenses sets the coma aberration generated in the peripheral side area in the wide-angle range to aberration appropriate for the correction by the image restoration in the image pickup apparatus, which enables performing good image restoration to improve image quality of the entire image area of the output image.

In the zoom lenses shown in FIGS. 1 and 3, the specific peripheral image area S shown in FIG. 16A is desirable to be set. Alternatively, in order to reduce data amount for the image restoration, the specific peripheral image area S shown in FIG. 16B may be set.

The specific peripheral image area S shown in FIG. 16B is set to, for example, an image area approximately from a 2-tenths (20%) image height to an 8-tenths (80%) image height from a center of the image plane IP in the wide-angle range, where a large outward coma aberration is generated.

In the above setting, in the more outer or outermost area N of the input image, a modulation transfer function (MTF) is deteriorated due to inward coma aberration and color flare.

However, this more outer or outermost area N of the input image is an area where image degradation occurs even if a general zoom lens is used whose aberration is optically corrected without assumption that the image restoration is performed, so that no image restoration is performed in this more outer or outermost area N of the input image.

Each of the zoom lenses shown in FIG. 2 and is a zoom lens designed on an assumption that the image restoration process is performed to correct an image degradation component (aberration ingredient) due to chromatic coma aberration in a telephoto range.

When the zoom lens having a magnification ratio of approximately 3.6× including the wide-angle range is provided with a large aperture diameter of approximately F1.7 to F1.8 also in a telephoto range, the third lens unit III is constituted by 5 or less lenses, also because of necessity of its miniaturization, and the chromatic coma aberration correctable by the image restoration is allowed. In particular in the peripheral side area, since aberration correction in the wide-angle range is also necessary, coma aberration for a g-line with respect to coma aberration for a d-line is suppressed to a level correctable by the image restoration, and in the central area, the chromatic coma aberration is optically well corrected to a level which needs no image restoration.

In the zoom lenses shown in FIGS. 2 and 3, as shown in FIG. 16C, the image restoration is assumed to be performed in the specific peripheral image area S corresponding to a 4-tenths (40%) image height or higher.

From the above description, the specific zoom range (specific magnification state) which is a target zoom range of the image restoration can be said as a zoom range where the image degradation component generated due to at least one of the coma aberration and the chromatic coma aberration in the specific peripheral image area S becomes larger than that in other zoom ranges.

It is desirable that the specific peripheral image area S where the image restoration is performed be an image area where, when the zoom lens is in the specific zoom range, an image degradation component (aberration component) is generated due to aberration which satisfies conditions shown by following expressions (1) and (2), that is, which is included in the following aberration ranges.

In the following expressions, “an upper ray” and “a lower ray” respectively mean, of an effective light flux (hereinafter referred to as “an image capturing light flux”) converted into the input image through image capturing by the image sensor, an upper ray and a lower ray of a light flux constituting a center side 7-tenths (70%) or 9-tenths (90%) part of a radius of the image capturing light flux from its center, which corresponds to an optical axis of the zoom lens, to its outermost periphery.

The upper ray and the lower ray of the light flux constituting the center side 7-tenths part are hereinafter respectively referred to as “a 7-tenths upper ray” and “a 7-tenths lower ray”. The upper ray and the lower ray of the light flux constituting the center side 9-tenths part are hereinafter respectively referred to as “a 9-tenths upper ray” and “a 9-tenths lower ray”.

Moreover, “an m-tenths image height position” means a position corresponding to m-tenths of the entire image height from a center of the image sensor (image plane).

0.00<|(ΔWyu2n+ΔWyl2n)/(ΔWyun+ΔWyln)|<0.8 (1)

0.75<|(ΔWyun+ΔWyln)|/2p<16.0 (2)

In the expressions (1) and (2), ΔWyu2n represents a lateral aberration amount of the 7-tenths upper ray of the d-line at a 2n-tenths image height position, and ΔWyl2n represents a lateral aberration amount of the 7-tenths lower ray of the d-line at the 2n-tenths image height position. Moreover, ΔWyun represents a lateral aberration amount of the 7-tenths upper ray of the d-line at an n-tenths image height position, and ΔWyln represents a lateral aberration amount of the 7-tenths lower ray of the d-line at the n-tenths image height position. Furthermore, p represents a pixel pitch of the image sensor used for the image capturing to acquire the input image.

Alternatively, the specific peripheral image area S may be an image area where, when the zoom lens is in the specific zoom range, an image degradation component is generated due to aberration which satisfies conditions shown by following expressions (3) and (2).

0.00<|(ΔWyu0.5n+ΔWyl0.5n)/(ΔWyun+ΔWyln)|<0.8 (3)

0.75<|(ΔWyun+ΔWyln)|/2p<16.0 (2)

In the expressions (3) and (2), ΔWyu0.5n represents a lateral aberration amount of the 7-tenths upper ray of the d-line at a 0.5n-tenths image height position, and ΔWyl0.5n represents a lateral aberration amount of the 7-tenths lower ray of the d-line at the 0.5n-tenths image height position. Moreover, as described above, ΔWyun represents the lateral aberration amount of the 7-tenths upper ray of the d-line at the n-tenths image height position, ΔWyln represents the lateral aberration amount of the 7-tenths lower ray of the d-line at the n-tenths image height position, and p represents the pixel pitch of the image sensor.

Moreover, the specific peripheral image area S may be an image area where, when the zoom lens is in the specific zoom range, an image degradation component is generated due to aberration which satisfies conditions shown by following expressions (4) and (5), in replace of or in addition to the conditions shown by expressions (1) to (3).

0.00<|(ΔWyu8+ΔWyl8)/(ΔWyu4+ΔWyl4)|<0.8 (4)

0.75<|(ΔWyu14+ΔWyl4)|/2p<16.0 (5)

In the expressions (4) and (5), ΔWyu8 represents a lateral aberration amount of the 9-tenths upper ray of the d-line at an 8-tenths image height position, and ΔWyl8 represents a lateral aberration amount of the 9-tenths lower ray of the d-line at the 8-tenths image height position. Moreover, ΔWyu4 represents a lateral aberration amount of the 9-tenths upper ray of the d-line at a 4-tenths image height position, ΔWyl4 represents a lateral aberration amount of the 9-tenths lower ray of the d-line at the 4-tenths image height position, and p represents the pixel pitch of the image sensor.

Furthermore, the specific peripheral image area S may be an image area where, when the zoom lens is in the specific zoom range, an image degradation component is generated due to aberration which satisfies conditions shown by following expressions (6) and (5), in replace of or in addition to the conditions shown by expressions (1) to (5).

0.00<|(ΔWyu2+ΔWyl2)/(ΔWyu4+ΔWyl4)|<1.5 (6)

0.75<|(ΔWyu4+ΔWyl4)|/2p<16.0 (5)

In the expressions (6) and (5), ΔWyu2 represents a lateral aberration amount of the 9-tenths upper ray of the d-line at a 2-tenths image height position, and ΔWyl2 represents a lateral aberration amount of the 9-tenths lower ray of the d-line at the 2-tenths image height position. Moreover, as described above, ΔWyu4 represents the lateral aberration amount of the 9-tenths upper ray of the d-line at the 4-tenths image height position, and ΔWyl4 represents the lateral aberration amount of the 9-tenths lower ray of the d-line at the 4-tenths image height position, and p represents the pixel pitch of the image sensor.

Furthermore, the specific peripheral image area S may be an image area where, when the zoom lens is in the specific zoom range, an image degradation component is generated due to aberration which satisfies conditions shown by following expressions (7) and (8), in replace of or in addition to the conditions shown by expressions (1) to (6).

0.00<|(ΔTgyun+ΔTgyln)/(ΔTgyu2n+ΔTgyl2n)|<0.67 (7)

0.75<|(ΔTgyu2n+ΔTgyl2n)|/2p<16.0 (8)

In the expressions (7) and (8), ΔTgyun represents a lateral aberration amount of the 7-tenths upper ray of the d-line at the n-tenths image height position, ΔTgyln represents a lateral aberration amount of the 7-tenths lower ray of the d-line at the n-tenths image height position. Moreover, ΔTgyu2n represents a lateral aberration amount of the 7-tenths upper ray of the d-line at the 2n-tenths image height position, ΔTgyl2n represents a lateral aberration amount of the 7-tenths lower ray of the d-line at the 2n-tenths image height position, and p represents the pixel pitch of the image sensor.

Furthermore, the specific peripheral image area S may be an image area where, when the zoom lens is in the specific zoom range, an image degradation component is generated due to aberration which satisfies conditions shown by following expressions (9) and (10), in replace of or in addition to the conditions shown by expressions (1) to (8).

0.00<|(ΔTgyu4+ΔTgyl4)/(ΔTgyl8+Tgyl8)|<0.67 (9)

0.75<|(ΔTgyu8+ΔTgyl8)|/2p<16.0 (10)

In the expressions (9) and (10), ΔTgyu4 represents a lateral aberration amount of the 7-tenths upper ray of the d-line at the 4-tenths image height position, ΔTgyl4 represents a lateral aberration amount of the 7-tenths lower ray of the d-line at the 4-tenths image height position. Moreover, ΔTgyu8 represents a lateral aberration amount of the 7-tenths upper ray of the d-line at the 8-tenths image height position, and ΔTgyl8 represents a lateral aberration amount of the 7-tenths lower ray of the d-line at the 8-tenths image height position, and p represents the pixel pitch of the image sensor.

Moreover, in the large aperture diameter zoom lens of each embodiment suitable for the partial image restoration and having a five-lens-unit configuration, the third lens unit III which is the main magnification-varying lens unit is desirable to satisfy the following condition in order to miniaturize the entire zoom lens:

1.6<f3/fw<2.6 (11)

where f3 represents a focal length of the third lens unit III, and fw represents a focal length of the entire zoom lens at the wide-angle end.

In each embodiment, the fourth lens unit IV is moved to perform focusing.

In this case, in order to achieve miniaturization of the entire zoom lens by reducing a movement amount of the fourth lens unit IV while sufficiently shortening a minimum object distance, the fourth lens unit IV is desirable to satisfy the following condition:

−3.0<f4/fw<−2.0 (12)

where f4 represents a focal length of the fourth lens unit IV.

Description will hereinafter be made of the meanings of the conditions shown by expressions (1) to (12).

The conditions shown by expressions (1) to (6) are conditions to provide, on the assumption that the image restoration is performed, a zoom lens suitable for decrease in size and increase in aperture diameter.

In order to miniaturize the zoom lens or to increase the aperture diameter thereof while providing a similar size to those of conventional zoom lenses, it is necessary to increase a refractive power of each of the lens units constituting the zoom lens.

However, increase of the refractive power of each lens unit is likely to increase aberration variation, especially variation of field curvature during zooming. Therefore, each embodiment generates, under an assumption that an image degradation component due to the field curvature is unsuitable for the image restoration, coma aberration in a partial range (specific magnification state) of the entire zoom range to suppress the variation of field curvature to an allowable range.

Additionally, each embodiment corrects the image degradation component due to the coma aberration by the image restoration to achieve a zoom lens whose field curvature is well corrected in the image acquired therethrough.

However, a too large amount of the coma aberration generated in the zoom lens with respect to the pixel pitch of the image sensor makes the image deterioration significant, which makes it impossible to sufficiently restore the degraded image by the image restoration.

On the other hand, an extremely increased degree of the image restoration produces an image whose noise is emphasized.

The conditions of expression (1) relates to a ratio of coma aberration of the 7-tenths upper and lower rays at the 2n-tenths image height position and coma aberration thereof at the n-tenths image height position.

A too large coma aberration at the 2n-tenths image height position making the value of expression (1) higher than the upper limit thereof significantly degrades the MTF in a high frequency range, which undesirably makes it difficult to provide an effect of the image restoration.

The value of expression (1) is an absolute value, so that it is always equal to or higher than the lower limit 0.

The condition of expression (2) relates to the coma aberration, which is normalized by the pixel pitch, of the 7-tenths upper and lower rays at the n-tenths image height position.

A too large coma aberration at the n-tenths image height position making the value of expression (2) higher than the upper limit thereof significantly degrades the MTF in the high frequency range, which undesirably makes it difficult to provide the effect of the image restoration. On the other hand, decreasing the coma aberration at the n-tenths image height position so as to make the value of expression (2) lower than the lower limit thereof requires increasing the number or diameters of lenses in order to increase the aperture diameter, which undesirably makes it difficult to achieve a compact zoom lens.

The condition of expression (3) relates to a ratio of coma aberration of the 7-tenths upper and lower rays at the 0.5n-tenths image height position and coma aberration thereof at the n-tenths image height position.

Decreasing the coma aberration at the n-tenths image height position so as to make the value of expression (3) higher than the upper limit thereof requires increasing the number or diameters of lenses in order to increase the aperture diameter, which undesirably makes it difficult to achieve a compact zoom lens.

The value of expression (3) is an absolute value, so that it is always equal to or higher than the lower limit 0.

The condition of expression (4) relates to a ratio of coma aberration of the 9-tenths upper and lower rays at the 8-tenths image height position and coma aberration thereof at the 4-tenths image height position.

A too large coma aberration at the 8-tenths image height position making the value of expression (4) higher than the upper limit thereof significantly degrades the MTF in the high frequency range, which undesirably makes it difficult to provide the effect of the image restoration.

The value of expression (4) is an absolute value, so that it is always equal to or higher than the lower limit 0.

The condition of expression (5) relates to the coma aberration, which is normalized by the pixel pitch, of the 9-tenths upper and lower rays at the 4-tenths image height position.

A too large coma aberration at the 4-tenths image height position making the value of expression (5) higher than the upper limit thereof significantly degrades the MTF in the high frequency range, which undesirably makes it difficult to provide the effect of the image restoration. On the other hand, decreasing the coma aberration at the 4-tenths image height position so as to make the value of expression (5) lower than the lower limit thereof requires increasing the number or diameters of lenses in order to increase the aperture diameter, which undesirably makes it difficult to achieve a compact zoom lens.

The condition of expression (6) relates to a ratio of coma aberration of the 9-tenths upper and lower rays at the 2-tenths image height position and coma aberration thereof at the 4-tenths image height position.

Decreasing the coma aberration at the 4-tenths image height position so as to make the value of expression (6) higher than the upper limit thereof requires increasing the number or diameters of lenses in order to increase the aperture diameter, which undesirably makes it difficult to achieve a compact zoom lens.

The value of expression (6) is an absolute value, so that it is always equal to or higher than the lower limit 0.

The conditions of expressions (7) to (12) are also conditions to provide, on the assumption that the image restoration is performed, a zoom lens suitable for decrease in size and increase in aperture diameter.

In order to increase the aperture diameter of the zoom lens also at the telephoto side, since it is necessary to correct chromatic aberration generated in the third lens unit III as the main magnification-varying lens unit, the number of lenses constituting the third lens unit III is likely to be increased, which results in increase in size of the zoom lens. Thus, in order to increase the aperture diameter while minimizing the number of the lenses constituting the third lens unit III, each embodiment generates chromatic coma aberration in a telephoto side partial range (specific magnification state) of the entire zoom range and corrects the chromatic coma aberration by the image restoration, thereby decreasing the size of the zoom lens and increasing the aperture diameter.

The condition of expression (7) relates to a ratio of chromatic coma aberration of the 7-tenths upper and lower rays at the n-tenths image height position and chromatic coma aberration thereof at the 2n-tenths image height position.

A too large chromatic coma aberration at the n-tenths image height position making the value of expression (7) higher than the upper limit thereof significantly degrades the MTF in the high frequency range, which undesirably makes it difficult to provide the effect of the image restoration.

The value of expression (7) is an absolute value, so that it is always equal to or higher than the lower limit 0.

The condition of expression (8) relates to the chromatic coma aberration, which is normalized by the pixel pitch, of the 7-tenths upper and lower rays at the 2n-tenths image height position.

A too large chromatic coma aberration at the 2n-tenths image height position making the value of expression (8) higher than the upper limit thereof significantly degrades the MTF in the high frequency range, which undesirably makes it difficult to provide the effect of the image restoration.

On the other hand, decreasing the chromatic coma aberration at the 2n-tenths image height position so as to make the value of expression (8) lower than the lower limit thereof requires increasing the number or diameters of lenses in order to increase the aperture diameter, which undesirably makes it difficult to achieve a compact zoom lens.

The condition of expression (9) relates to a ratio of chromatic coma aberration of the 7-tenths upper and lower rays at the 4-tenths image height position and chromatic coma aberration thereof at the 8-tenths image height position.

A too large chromatic coma aberration at the 4-tenths image height position making the value of expression (9) higher than the upper limit thereof significantly degrades the MTF in the high frequency range, which undesirably makes it difficult to provide the effect of the image restoration.

The value of expression (9) is an absolute value, so that it is always equal to or higher than the lower limit 0.

The condition of expression (10) relates to the chromatic coma aberration, which is normalized by the pixel pitch, of the 7-tenths upper and lower rays at the 8-tenths image height position.

A too large chromatic coma aberration at the 8-tenths image height position making the value of expression (10) higher than the upper limit thereof significantly degrades the MTF in the high frequency range, which undesirably makes it difficult to provide the effect of the image restoration. On the other hand, decreasing the chromatic coma aberration at the 8-tenths image height position so as to make the value of expression (10) lower than the lower limit thereof requires increasing the number or diameters of lenses in order to increase the aperture diameter, which undesirably makes it difficult to achieve a compact zoom lens.

The condition of expression (11) relates to the focal length of the third lens unit III, which is normalized by the focal length of the entire zoom lens at the wide-angle end.

A too long focal length of the third lens unit III making the value of expression (11) higher than the upper limit thereof increases the entire length of the zoom lens and the diameter of the first lens unit I, which undesirably increases the size of the zoom lens.

On the other hand, a too short focal length of the third lens unit III making the value of expression (11) lower than the lower limit thereof makes it difficult to sufficiently correct the coma aberration and the chromatic coma aberration generated in the peripheral side area in the entire zoom range with a small number of lenses, which is undesirable.

The conditions of expression (12) relates to the focal length of the fourth lens unit IV, which is normalized by the focal length of the entire zoom lens at the wide-angle end.

A too short focal length of the fourth lens unit IV making the value of expression (12) higher than the upper limit thereof makes it difficult to sufficiently correct variation of field curvature during focusing, which is undesirable.

On the other hand, a too long focal length of the fourth lens unit IV making the value of expression (12) lower than the lower limit thereof increases the movement amount of the fourth lens unit IV and thereby makes it necessary to provide a movement margin for focusing, which undesirably increases the entire zoom lens.

Satisfying the following conditions of expressions (1d) to (12d) whose ranges between the upper and lower limits are narrowed as compared with expressions (1) to (12) can provide more sufficient effects described above, which is more desirable.

0.1<|(ΔWyu2n+ΔWyl2n)/(ΔWyun+ΔWyln)|<0.7 (1d)

0.75<|(ΔWyun+ΔWyln)|/2p<13.0( 2d)

0.2<|(ΔWyu0.5n+ΔWyl0.5n)/(ΔWyun+ΔWyln)|<0.8 (3d)

0.75<|(ΔWyun+ΔWyln)|/2p<13.0 (2d)

0.1<|(ΔWyu8+ΔWyl8)/(ΔWyu4+ΔWyl4)|<0.7 (4d)

0.75<|(ΔWyu4+ΔWyl4)|/2p<13.0 (5d)

0.1<|(ΔWyu2+ΔWyl2)/(ΔWyu4+ΔWyl4)|<0.8 (6d)

0.75<|(ΔWyu4+ΔWyl4)|/2p<13.0 (5d)

0.1<|(ΔTgyun+ΔTgyln)/(ΔTgyu2n+ΔTgyl2n)|<0.5 (7d)

0.75<|(ΔTgyu2n+ΔTgyl2n)|/2p<15.0 (8d)

0.1<|(ΔTgyu4+ΔTgyl4)/(ΔTgyu8+ΔTgyl8)|<0.5 (9d)

0.75<|(ΔTgyu8+ΔTgyl8)|/2p<15.0 (10d)

1.7<f3/fw<2.4 (11d)

−2.9<f4/fw<−2.2 (12d)

The zoom lenses shown in FIGS. 1 to 3 each have, as mentioned above, the five-lens-unit configuration including positive, negative, positive, negative and positive lens units in order from the object side.

During zooming between two arbitrary zoom positions, a distance between the first and second lens units I and II increases, a distance between the second and third lens units II and III decreases, a distance between the third and fourth lens units III and IV increases, and a distance between the fourth and fifth lens units IV and V changes.

In the zoom lenses shown in FIGS. 1 and 2, the first lens unit I is constituted by a cemented lens in which two negative and positive lenses are cemented, and the second lens unit II is constituted by three negative, negative and positive lenses. The third lens unit III is constituted by a cemented lens in which three positive, negative and positive lenses are cemented and another cemented lens in which two negative and positive lenses are cemented, which means that the third lens unit III is constituted by five lenses in total.

The fourth lens unit IV is constituted by two positive and negative lenses, and the fifth lens unit V is constituted by one positive lens.

In the zoom lens shown in FIG. 3, the first lens unit I is constituted by a cemented lens in which two negative and positive lenses are cemented, and the second lens unit II is constituted by four negative, negative, negative and positive lenses. The third lens unit III is constituted by a cemented lens in which three positive, negative and positive lenses are cemented and another cemented lens in which two negative and positive lenses are cemented, which means that the third lens unit III is constituted by five lenses in total.

The fourth lens unit IV is constituted by a cemented lens in which two positive and negative lenses are cemented, and the fifth lens unit V is constituted by one positive lens.

Moreover, the zoom lenses shown in FIGS. 1 to 3 each have an image stabilizing mechanism that shifts the entire third lens unit III in a direction orthogonal to the optical axis to correct image blur due to hand jiggling.

In addition, the fourth lens unit IV is moved in a direction of the optical axis (optical axis direction) to perform focusing.

The focusing may be performed by moving the second lens unit II, the fifth lens unit V or part of the third lens unit III in the optical axis direction.

Next, specific numerical values of the zoom lenses of FIGS. 1 to 3 are shown as Numerical Examples 1 to 3. In each numerical example, i represents an ordinal number of lens surfaces or lenses counted from the object side, ri (i=1, 2, 3, . . . ) represents a curvature radius of an i-th lens surface counted from the object side, and di represents a thickness or an aerial distance between the i-th lens surface and an (i+1)-th lens surface. Moreover, ndi and νdi respectively represent a refractive index and an Abbe number of a material of an i-th lens for the d-line. When the lens surface has an aspheric shape, which is shown by “*”, the aspheric shape is expressed by the following expression where U represents a curvature radius at a central portion of the lens surface, X represents position (coordinate) in the optical axis direction, Y represents position (coordinate) in the direction orthogonal to the optical axis direction, and Ai (i=1, 2, 3, . . . ) represents an aspheric coefficient:

X=(Y²/U)/{1+[1−(K+1)(Y/U)²]^{1/2}}+A4Y⁴+A6Y⁶+ . . .

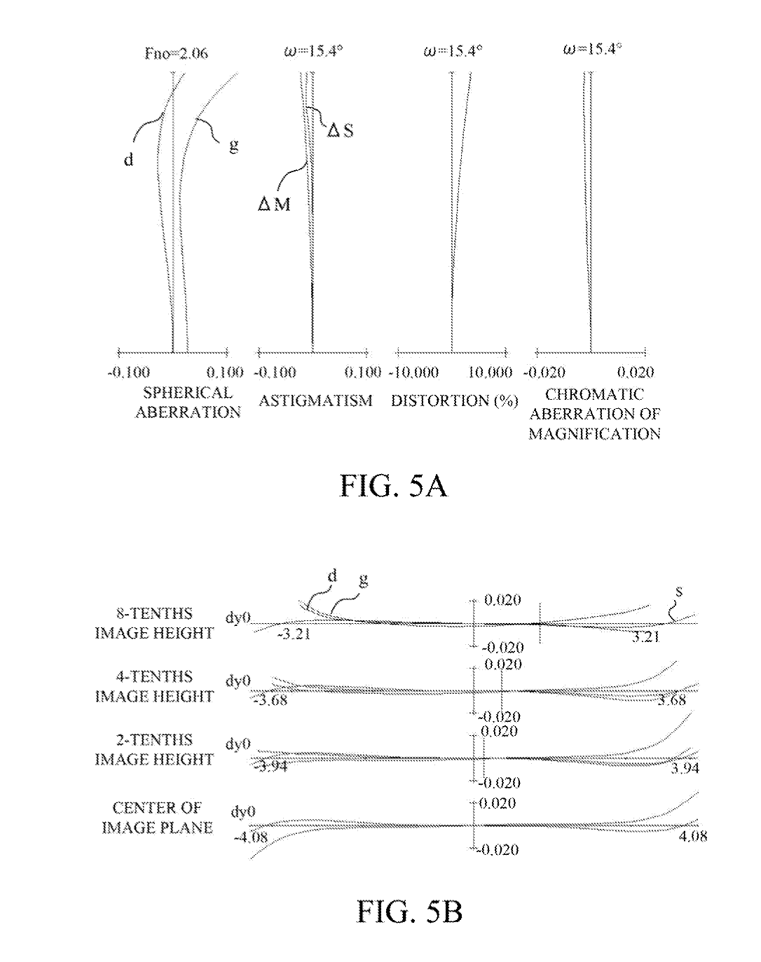

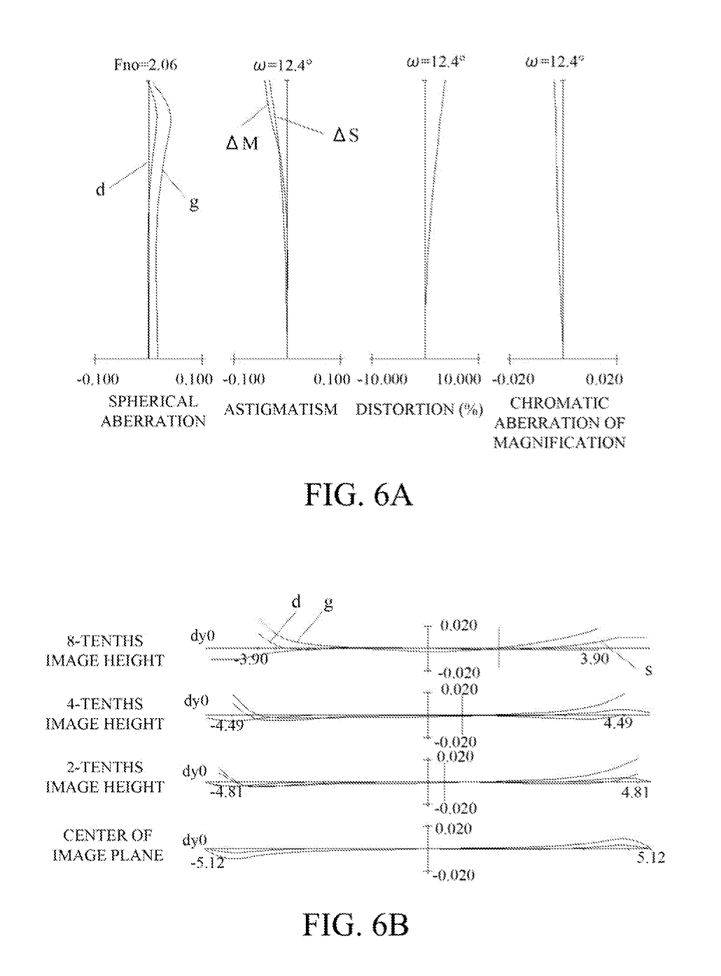

FIGS. 4A, 5A and 6A respectively show longitudinal aberrations (spherical aberration, astigmatism, distortion and chromatic aberration of magnification) of the zoom lens shown in FIG. 1 when the zoom lens is at the wide angle end, the middle zoom position and telephoto end.

In these figures, Fno represents an F-number, and co represents a half angle of view.

Moreover, d represents the spherical aberration for the d-line, and g represents the spherical aberration for the g-line. In addition, ΔS represents astigmatism in a sagittal plane, and ΔM shows astigmatism in a meridional plane.

FIGS. 4B, 5B and 6B respectively show lateral aberrations of the zoom lens shown in FIG. 1 at the center of the image plane, the 2-tenths image height position, the 4-tenths image height position and the 8-tenths image height position when the zoom lens is at the wide angle end, the middle zoom position and telephoto end.

In these figures, d represents the lateral aberration for the d-line, g represents the lateral aberration for the g-line, and s represents the lateral aberration for an s-line.

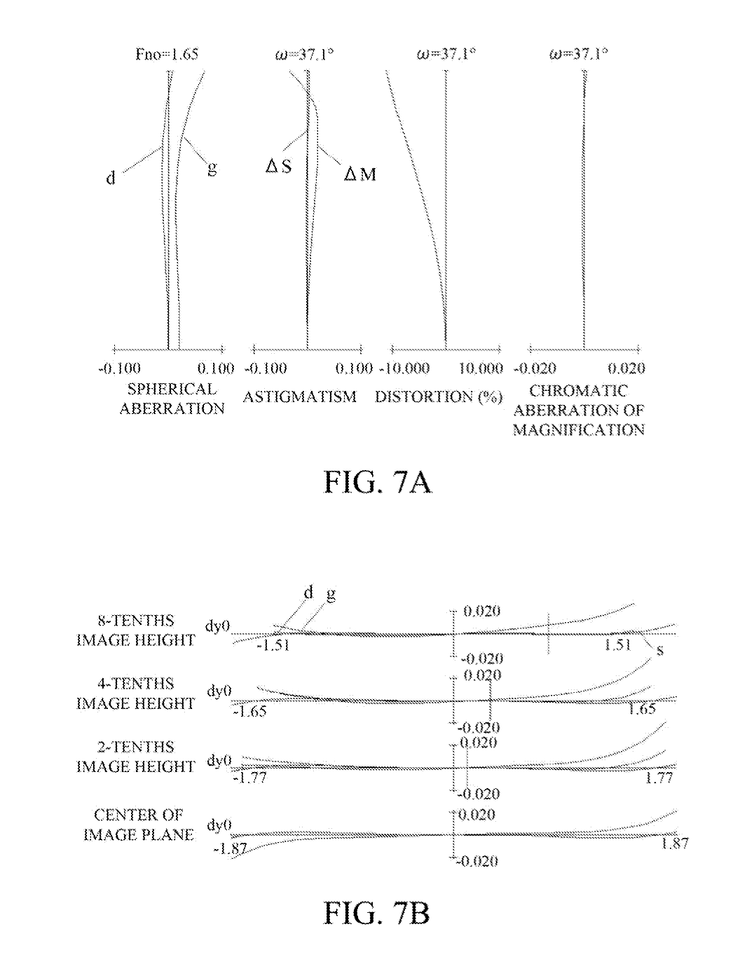

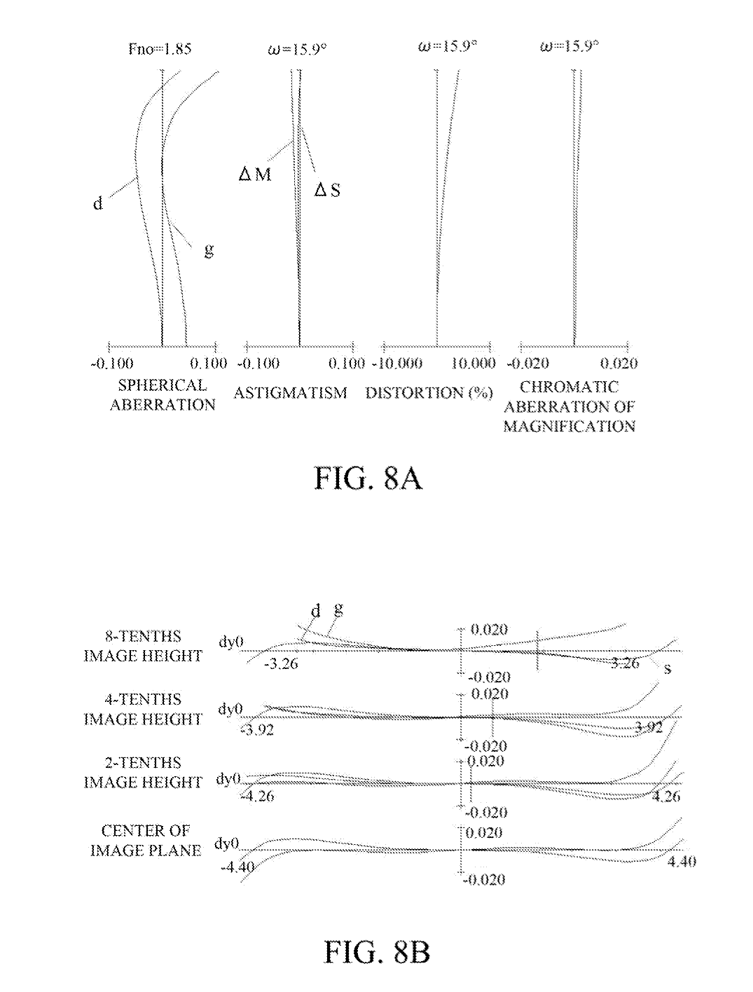

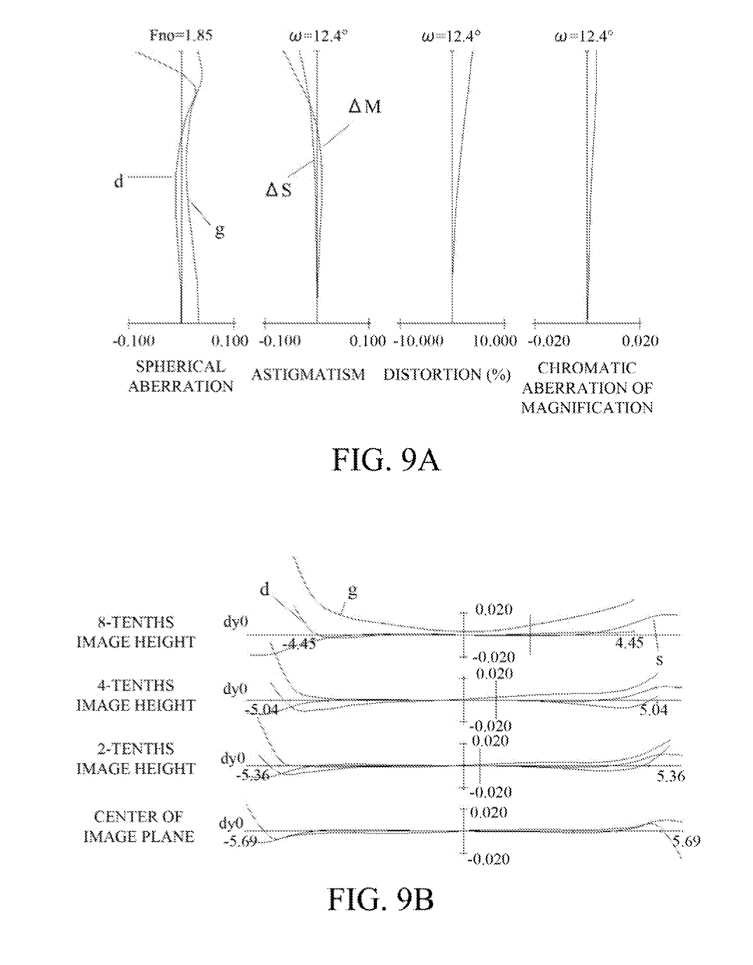

Similarly, FIGS. 7A, 8A and 9A respectively show the longitudinal aberrations of the zoom lens shown in FIG. 2 when the zoom lens is at the wide angle end, the middle zoom position and telephoto end.

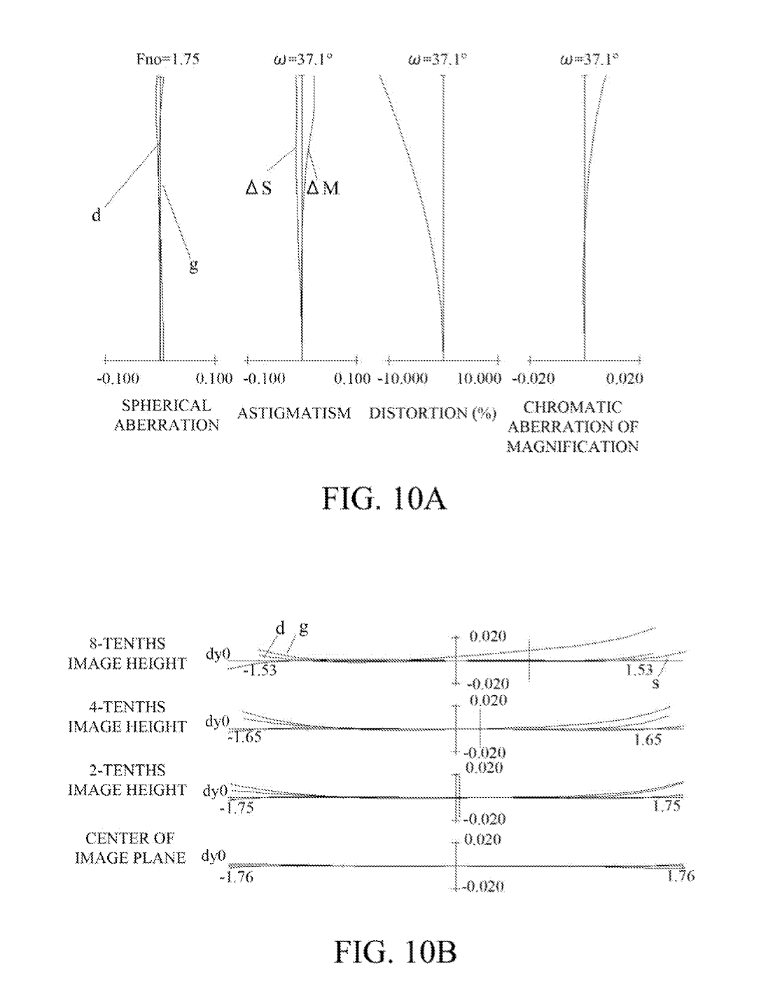

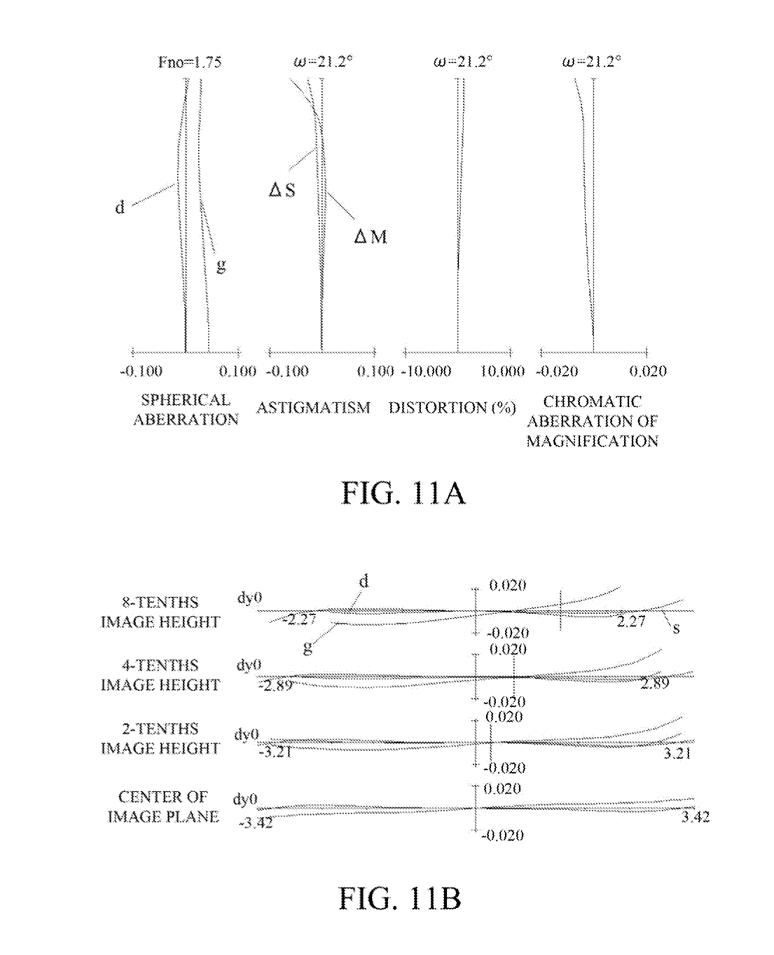

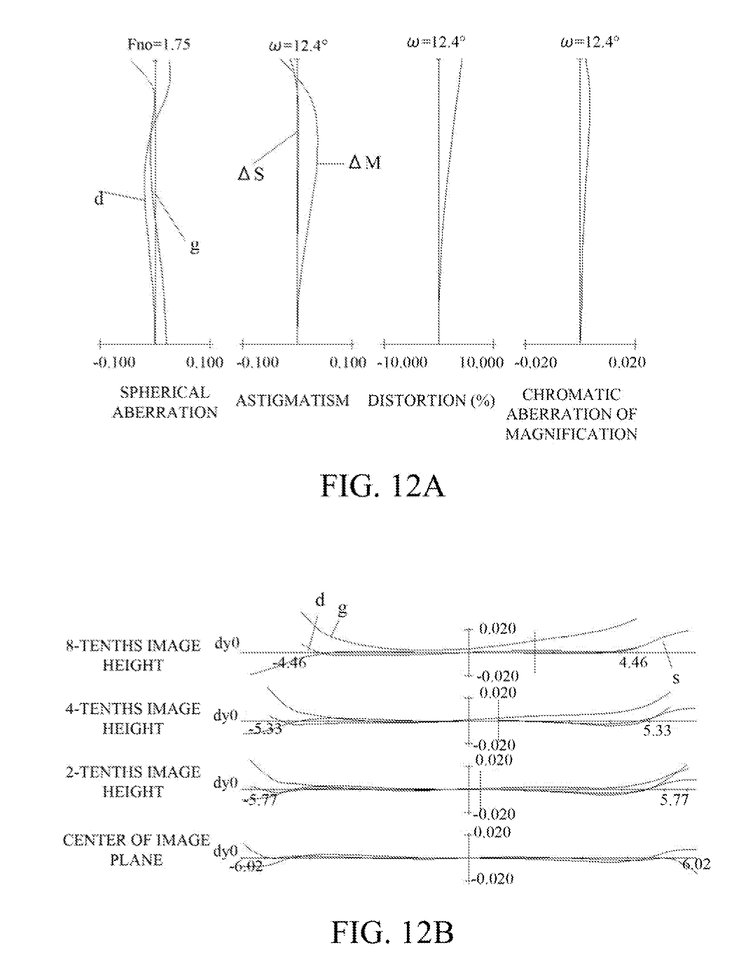

FIGS. 7B, 8B and 9B respectively show the lateral aberrations of the zoom lens shown in FIG. 2 at the center of the image plane, the 2-tenths image height position, the 4-tenths image height position and the 8-tenths image height position when the zoom lens is at the wide angle end, the middle zoom position and telephoto end. Furthermore, FIGS. 10A, 11A and 12A respectively show the longitudinal aberrations of the zoom lens shown in FIG. 3 when the zoom lens is at the wide angle end, the middle zoom position and telephoto end.

FIGS. 10B, 11B and 12B respectively show the lateral aberrations of the zoom lens shown in FIG. 3 at the center of the image plane, the 2-tenths image height position, the 4-tenths image height position and the 8-tenths image height position when the zoom lens is at the wide angle end, the middle zoom position and telephoto end.

Table 1 collectively shows the values of expressions (1) to (12) in Numerical Examples 1 to 3.

### Numerical Example 1

Unit mm
Surface Data

| Surface No. | r | d | nd | νd |
|---|---|---|---|---|
| 1 | 29.212 | 1.00 | 1.85478 | 24.8 |
| 2 | 22.533 | 4.59 | 1.69680 | 55.5 |
| 3 | 158.202 | (Variable) | | |
| 4 | 47.966 | 0.80 | 1.88300 | 40.8 |
| 5 | 8.286 | 5.23 | | |
| 6 | −26.220 | 0.80 | 1.60311 | 60.6 |
| 7 | 21.269 | 0.30 | | |
| 8 | 17.262 | 1.87 | 1.95906 | 17.5 |
| 9 | 65.560 | (Variable) | | |
| 10 (SP) | ∞ | (Variable) | | |
| 11* | 14.352 | 3.05 | 1.76802 | 49.2 |
| 12* | −34.522 | 0.80 | | |
| 13 | −20.792 | 0.70 | 1.64769 | 33.8 |
| 14 | −90.681 | 1.66 | 1.88300 | 40.8 |
| 15 | −19.689 | 1.08 | | |
| 16 | 27.593 | 0.70 | 1.92286 | 18.9 |
| 17 | 8.596 | 4.22 | 1.49700 | 81.5 |
| 18 | −15.334 | (Variable) | | |
| 19 | 10.732 | 1.20 | 2.00272 | 19.3 |
| 20 | 18.599 | 0.41 | | |
| 21 | 185.646 | 0.60 | 1.77250 | 49.6 |
| 22 | 6.665 | (Variable) | | |
| 23* | 19.210 | 1.76 | 1.85135 | 40.1 |
| 24 | −304.702 | 1.82 | | |
| 25 | ∞ | 1.10 | 1.51633 | 64.1 |
| 26 | ∞ | 1.41 | | |
| IP | ∞ | | | |

Aspheric Surface Data

| | | |
|---|---|---|
| 11-th surface | | |
| K = −4.89421e−001 | A 4 = −4.94712e−005 | A 6 = |
| | | 3.24154e−008 |
| 12-th surface | | |
| K = 2.48094e+000 | A 4 = 1.05700e−004 | |
| 23-rd surface | | |
| K = 0.00000e+000 | A4 = 5.58902e−005 | A6 = |
| | | 1.60547e−006 |

Various Data

| | |
|---|---|
| Zoom ratio | 3.43 |

| | WIDE | MIDDLE | TELE |
|---|---|---|---|
| Focal Length | 6.15 | 16.83 | 21.08 |
| F-NUMBER | 1.85 | 2.06 | 2.06 |
| Angle of View | 37.08 | 15.44 | 12.44 |
| Image Height | 4.65 | 4.65 | 4.65 |
| Entire Lens Length | 60.93 | 61.90 | 63.49 |
| Back Focus | 3.96 | 3.96 | 3.96 |
| d 3 | 0.35 | 12.06 | 14.37 |
| d 9 | 17.00 | 5.00 | 2.05 |
| d10 | 3.82 | 0.68 | 1.50 |
| d18 | 0.53 | 3.51 | 4.15 |
| d22 | 4.48 | 5.91 | 6.68 |
| d24 | 1.82 | 1.82 | 1.82 |
| d26 | 1.41 | 1.41 | 1.41 |

Lens Unit Data

| Unit | Starting Surface | Focal Length |
|---|---|---|
| 1 | 1 | 54.67 |
| 2 | 4 | −9.93 |
| 3 | 10 | ∞ |
| 4 | 11 | 11.62 |
| 5 | 19 | −16.90 |
| 6 | 23 | 21.28 |
| 7 | 25 | ∞ |

### Numerical Example 2

Unit mm
Surface Data

| Surface No. | r | d | nd | νd |
|---|---|---|---|---|
| 1 | 28.138 | 1.00 | 1.85478 | 24.8 |
| 2 | 22.298 | 4.75 | 1.69680 | 55.5 |
| 3 | 187.703 | (Variable) | | |
| 4 | 79.123 | 0.80 | 1.88300 | 40.8 |
| 5 | 8.672 | 5.20 | | |
| 6 | −24.003 | 0.80 | 1.60311 | 60.6 |
| 7 | 22.574 | 0.30 | | |
| 8 | 18.503 | 1.90 | 1.95906 | 17.5 |
| 9 | 85.023 | (Variable) | | |
| 10 (SP) | ∞ | (Variable) | | |
| 11* | 14.007 | 3.34 | 1.76802 | 49.2 |
| 12* | −34.229 | 0.96 | | |
| 13 | −22.090 | 0.70 | 1.64769 | 33.8 |
| 14 | −36.694 | 1.44 | 1.88300 | 40.8 |
| 15 | −19.427 | 0.72 | | |
| 16 | 24.306 | 0.70 | 1.92286 | 18.9 |
| 17 | 8.365 | 4.93 | 1.49700 | 81.5 |
| 18 | −16.444 | (Variable) | | |
| 19 | 9.582 | 1.20 | 2.00272 | 19.3 |
| 20 | 12.963 | 0.54 | | |
| 21 | 79.010 | 0.60 | 1.77250 | 49.6 |
| 22 | 6.277 | (Variable) | | |
| 23* | 17.603 | 1.96 | 1.85135 | 40.1 |
| 24 | −71.100 | 1.82 | | |
| 25 | ∞ | 1.10 | 1.51633 | 64.1 |
| 26 | ∞ | 1.37 | | |
| IP | ∞ | | | |

Aspheric Surface Data

| | | |
|---|---|---|
| 11−th surface | | |
| K = −5.30157e−001 | A 4 = −4.66161e−005 | A 6 = |
| | | 7.11067e−008 |
| 12−th surface | | |
| K = 1.38998e+000 | A 4 = 1.02497e−004 | |
| 23−rd surface | | |
| K = 0.00000e+000 | A 4 = 6.24990e−005 | A 6 = |
| | | 1.82605e−006 |

Various Data

| | |
|---|---|
| Zoom ratio | 3.42 |

| | WIDE | MIDDLE | TELE |
|---|---|---|---|
| Focal Length | 6.16 | 16.27 | 21.07 |
| F−NUMBER | 1.65 | 1.85 | 1.85 |
| Angle of View | 37.05 | 15.94 | 12.44 |
| Image Height | 4.65 | 4.65 | 4.65 |
| Entire Lens Length | 60.93 | 60.58 | 62.61 |
| Back Focus | 3.92 | 3.92 | 3.92 |
| d 3 | 0.35 | 10.49 | 12.84 |
| d 9 | 15.70 | 1.62 | 2.04 |
| d10 | 4.63 | 4.02 | 1.49 |
| d18 | 0.48 | 3.65 | 4.15 |
| d22 | 4.01 | 5.02 | 6.33 |

Lens Unit Data

| Unit | Starting Surface | Focal Length |
|---|---|---|
| 1 | 1 | 50.00 |
| 2 | 4 | −9.55 |
| 3 | 10 | ∞ |
| 4 | 11 | 11.59 |
| 5 | 19 | −14.22 |
| 6 | 23 | 16.74 |
| 7 | 25 | ∞ |

### Numerical Example 3

Unit mm
Surface Data

| Surface No. | r | d | nd | νd |
|---|---|---|---|---|
| 1 | 36.971 | 1.00 | 1.85478 | 24.8 |
| 2 | 35.065 | 3.52 | 1.69680 | 55.5 |
| 3 | 112.424 | (Variable) | | |
| 4 | 68.023 | 0.80 | 1.88300 | 40.8 |
| 5 | 12.500 | 5.01 | | |
| 6 | −172.284 | 0.60 | 1.48749 | 70.2 |
| 7 | 57.317 | 2.33 | | |
| 8 | −33.186 | 0.60 | 1.55332 | 71.7 |
| 9* | 39.572 | 0.30 | | |
| 10 | 27.932 | 2.02 | 1.95906 | 17.5 |
| 11 | 203.858 | (Variable) | | |
| 12 (SP) | ∞ | (Variable) | | |
| 13* | 14.936 | 3.30 | 1.76802 | 49.2 |
| 14* | −44.584 | 1.29 | | |
| 15 | −16.044 | 0.70 | 1.64769 | 33.8 |
| 16 | 52.059 | 2.66 | 1.88300 | 40.8 |
| 17 | −19.453 | 0.28 | | |
| 18 | 15.329 | 0.70 | 1.92286 | 18.9 |
| 19 | 7.177 | 4.12 | 1.49700 | 81.5 |
| 20 | 277.152 | (Variable) | | |
| 21 | 15.350 | 1.50 | 2.00272 | 19.3 |
| 22 | −49.126 | 0.60 | 1.74400 | 44.8 |
| 23 | 26.566 | 0.49 | | |
| 24 | −40.615 | 0.60 | 1.68893 | 31.1 |
| 25 | 6.768 | (Variable) | | |
| 26* | 18.530 | 2.38 | 1.85135 | 40.1 |
| 27 | −23.574 | 1.82 | | |
| 28 | ∞ | 1.10 | 1.51633 | 64.1 |
| 29 | ∞ | 1.42 | | |
| IP | ∞ | | | |

Aspheric Surface Data

| | | |
|---|---|---|
| 9−th surface | | |
| K = 0.00000e+000 | A 4 = 6.86394e−006 | A 6 = |
| | | 5.20200e−008 |
| 13−th surface | | |
| K = −2.27041e+000 | A 4 = 2.52289e−005 | A 6 = |
| | | −1.71146e−007 |
| 14−th surface | | |
| K = 3.75144e+000 | A 4 = 1.16801e−005 | |
| 26−th surface | | |
| K = 0.00000e+000 | A 4 = | A 6 = |
| | −1.84721e−005 | 1.93814e−006 |

Various Data

| | |
|---|---|
| Zoom ratio | 3.43 |

| | WIDE | MIDDLE | TELE |
|---|---|---|---|
| Focal Length | 6.15 | 11.96 | 21.08 |
| F−NUMBER | 1.75 | 1.75 | 1.75 |
| Angle of View | 37.07 | 21.24 | 12.44 |
| Image Height | 4.65 | 4.65 | 4.65 |
| Entire Lens Length | 71.43 | 66.90 | 72.98 |
| Back Focus | 3.97 | 3.97 | 3.97 |
| d 3 | 0.35 | 8.93 | 20.39 |
| d11 | 24.50 | 4.01 | 2.05 |
| d12 | 3.31 | 7.48 | 1.50 |
| d20 | 0.48 | 2.84 | 5.32 |
| d25 | 4.02 | 4.87 | 4.96 |

Lens Unit Data

| Unit | Starting Surface | Focal Length |
|---|---|---|
| 1 | 1 | 78.18 |
| 2 | 4 | −13.85 |
| 3 | 12 | ∞ |
| 4 | 13 | 13.53 |
| 5 | 21 | −16.11 |
| 6 | 26 | 12.51 |
| 7 | 28 | ∞ |

TABLE 1

| | | Numerical | Numerical | Numerical | |
|---|---|---|---|---|---|
| | | Example 1 | Example 2 | Example 3 | |
| (1) | \| (ΔWyu2n + ΔWyl2n)/(ΔWyun + ΔWyln)\| | 0.182 | 0.676 | 0.006 | (n = 4) |
| (2) | \| (ΔWyun + ΔWyln)\|/2p | 4.096 | 0.768 | 9.332 | (n = 4) |
| (3) | \| (ΔWyu0.5n + ΔWyl0.5n)/(ΔWyun + ΔWyln)\| | 0.718 | 1.413 | 0.150 | (n = 4) |
| (7) | \| (ΔTgyun + ΔTgyln)/(ΔTgyu2n + ΔTgyl2n)\| | 0.141 | 0.230 | 0.396 | (n = 4) |
| (8) | \| (ΔTgyu2n + ΔTgyl2n)\|/2p | 3.702 | 12.446 | 9.014 | (n = 4) |
| (4) | \| (ΔWyu8 + ΔWyl8)/(ΔWyu4 + ΔWyl4)\| | 0.182 | 0.676 | 0.006 | |
| (5) | \| (ΔWyu4 + ΔWyl4)\|/2p | 4.096 | 0.768 | 9.332 | |
| (6) | \| (ΔWyu2 + ΔWyl2)/(ΔWyu4 + ΔWyl4)\| | 0.718 | 1.413 | 0.150 | |
| — | \| (ΔWyu2 + ΔWyl2)\|/2p | 2.943 | 1.086 | 1.400 | |
| (9) | \| (ΔTgyu4 + ΔTgyl4)/(ΔTgyu8 + ΔTgyl8)\| | 0.141 | 0.230 | 0.396 | |
| (10) | \| (ΔTgyu8 + ΔTgyl8)\|/2p | 3.702 | 12.446 | 9.014 | |
| (11) | f3/fw | 1.89 | 1.88 | 2.20 | |
| (12) | f4/fw | −2.75 | −2.31 | −2.62 | |

In Table 1, the values of expressions (1) to (3), (7) and (8) are values when n is 4.

The values of expressions (1) to (6) are values at the wide angle end, and the values of expressions (7) to (10) are values at the telephoto end.

As described above, the zoom lens of each embodiment enables fast and good image restoration while achieving increase in size and decreasing in aperture diameter on the assumption that the image restoration is performed.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-004355, filed on Jan. 15, 2013, which is hereby incorporated by reference herein in its entirety.

What is claimed is:

1. An image processing apparatus comprising:
an image acquirer configured to acquire an input image produced by image capturing through a zoom lens whose magnification is variable; and
a processor configured to perform an image restoration process using an image restoration filter produced on a basis of information on aberration of the zoom lens,
wherein the processor is configured to not perform the image restoration process on a central image area of the input image produced by the image capturing through the zoom lens set in a specific magnification state and to perform the image restoration process on a specific image area more outer than the central image area of that input image.

2. An image processing apparatus according to claim 1, wherein the specific magnification state is a magnification state where the specific image area includes a larger aberration component generated due to at least one of coma aberration and chromatic coma aberration of the zoom lens as compared with other magnification states.

3. An image processing apparatus according to claim 1, wherein the specific magnification state includes a wide-angle end state.

4. An image processing apparatus according to claim 1, wherein aberration of the zoom lens set in the specific magnification state is within the following ranges:
0.00<|(ΔWyu2n+ΔWyl2n)/(ΔWyun+ΔWyln)|<0.8
0.75<|(ΔWyun+ΔWyln)|/2p<16.0
where, when, of an image capturing light flux converted into the input image by the image capturing, an upper ray and a lower ray of a light flux constituting a center side 7-tenths part of a radius of the image capturing light flux from its center to its outermost periphery are respectively referred to as a 7-tenths upper ray and a 7-tenths lower ray, and a position corresponding to m-tenths of an entire image height is referred to as an m-tenths image height position,
ΔWyu2n represents a lateral aberration amount of the 7-tenths upper ray of a d-line at a 2n-tenths image height position, ΔWyl2n represents a lateral aberration amount of the 7-tenths lower ray of the d-line at the 2n-tenths image height position,
ΔWyun represents a lateral aberration amount of the 7-tenths upper ray of the d-line at an n-tenths image height position, ΔWyln represents a lateral aberration amount of the 7-tenths lower ray of the d-line at the n-tenths image height position, and p represents a pixel pitch of an image sensor used for the image capturing to acquire the input image.

5. An image processing apparatus according to claim 1, wherein aberration of the zoom lens set in the specific magnification state is within the following ranges:
0.00<|(ΔWyu0.5n+ΔWyl0.5n)/(ΔWyun+ΔWyln)|<0.8
0.75<|(ΔWyun+ΔWyln)|/2p<16.0
where, when, of an image capturing light flux converted into the input image by the image capturing, an upper ray and a lower ray of a light flux constituting a center side 7-tenths part of a radius of the image capturing light flux from its center to its outermost periphery are respectively referred to as a 7-tenths upper ray and a 7-tenths lower ray, and a position corresponding to m-tenths of an entire image height is referred to as an m-tenths image height position,
ΔWyu0.5n represents a lateral aberration amount of the 7-tenths upper ray of a d-line at a 0.5n-tenths image height position, ΔWyl0.5n represents a lateral aberration amount of the 7-tenths lower ray of the d-line at the 0.5n-tenths image height position,
ΔWyun represents a lateral aberration amount of the 7-tenths upper ray of the d-line at an n-tenths image height position, ΔWyln represents a lateral aberration amount of the 7-tenths lower ray of the d-line at the n-tenths image height position, and p represents a pixel pitch of an image sensor used for the image capturing to acquire the input image.

6. An image processing apparatus according to claim 1, wherein aberration of the zoom lens set in the specific magnification state is within the following ranges:
0.00<|(ΔWyu8+ΔWyl8)/(ΔWyu4+ΔWyl4)|<0.8
0.75<|(ΔWyu4+ΔWyl)|/2p<16.0
where, when, of an image capturing light flux converted into the input image by the image capturing, an upper ray and a lower ray of a light flux constituting a center side 9-tenths part of a radius of the image capturing light flux from its center to its outermost periphery are respectively referred to as a 9-tenths upper ray and a 9-tenths lower ray, and a position corresponding to m-tenths of an entire image height is referred to as an m-tenths image height position,
ΔWyu8 represents a lateral aberration amount of the 9-tenths upper ray of a d-line at an 8-tenths image height position, ΔWyl8 represents a lateral aberration amount of the 9-tenths lower ray of the d-line at the 8-tenths image height position,
ΔWyu4 represents a lateral aberration amount of the 9-tenths upper ray of the d-line at a 4-tenths image height position, ΔWyl4 represents a lateral aberration amount of the 9-tenths lower ray of the d-line at the 4-tenths image height position, and p represents a pixel pitch of an image sensor used for the image capturing to acquire the input image.

7. An image processing apparatus according to claim 1, wherein aberration of the zoom lens set in the specific magnification state is within the following ranges:
0.00<|(ΔWyu2+ΔWyl2)/(ΔWyu4+ΔWyl4)|<1.5
0.75<|(ΔWyu4+ΔWyl4)|/2p<16.0
where, when, of an image capturing light flux converted into the input image by the image capturing, an upper ray and a lower ray of a light flux constituting a center side 9-tenths part of a radius of the image capturing light flux from its center to its outermost periphery are respectively referred to as a 9-tenths upper ray and a 9-tenths lower ray, and a position corresponding to m-tenths of an entire image height is referred to as an m-tenths image height position,
ΔWyu2 represents a lateral aberration amount of the 9-tenths upper ray of a d-line at a 2-tenths image height position, ΔWyl2 represents a lateral aberration amount of the 9-tenths lower ray of the d-line at the 2-tenths image height position,
ΔWyu4 represents a lateral aberration amount of the 9-tenths upper ray of the d-line at a 4-tenths image height position, ΔWyl4 represents a lateral aberration amount of the 9-tenths lower ray of the d-line at the 4-tenths image height position, and p represents a pixel pitch of an image sensor used for the image capturing to acquire the input image.

8. An image processing apparatus according to claim 1, wherein the specific magnification state includes a telephoto end state.

9. An image processing apparatus according to claim 1, wherein aberration of the zoom lens set in the specific magnification state is within the following ranges:
0.00<|(ΔTgyun+ΔTgyln)/(ΔTgyu2n+ΔTgyl2n)|<0.67
0.75<|(ΔTgyu2n+ΔTgyl2n)|/2p<16.0
where, when, of an image capturing light flux converted into the input image by the image capturing, an upper ray and a lower ray of a light flux constituting a center side 7-tenths part of a radius of the image capturing light flux from its center to its outermost periphery are respectively referred to as a 7-tenths upper ray and a 7-tenths lower ray, and a position corresponding to m-tenths of an entire image height is referred to as an m-tenths image height position,
ΔTgyun represents a lateral aberration amount of the 7-tenths upper ray of a g-line at an n-tenths image height position, ΔTgyln represents a lateral aberration amount of the 7-tenths lower ray of the g-line at the n-tenths image height position,
ΔTgyu2n represents a lateral aberration amount of the 7-tenths upper ray of the g-line at a 2n-tenths image height position, ΔTgyl2n represents a lateral aberration amount of the 7-tenths lower ray of the g-line at the 2n-tenths image height position, and p represents a pixel pitch of an image sensor used for the image capturing to acquire the input image.

10. An image processing apparatus according to claim 1, wherein aberration of the zoom lens set in the specific magnification state is within the following ranges:
0.00<|(ΔTgyu4+ΔTgyl4)/(ΔTgyu8+ΔTgyl8)|<0.67
0.75<|(ΔTgyu8+ΔTgyl8)|/2p<16.0
where, when, of an image capturing light flux converted into the input image by the image capturing, an upper ray and a lower ray of a light flux constituting a center side 7-tenths part of a radius of the image capturing light flux from its center to its outermost periphery are respectively referred to as a 7-tenths upper ray and a 7-tenths lower ray, and a position corresponding to m-tenths of an entire image height is referred to as an m-tenths image height position,
ΔTgyu4 represents a lateral aberration amount of the 7-tenths upper ray of a g-line at a 4-tenths image height position, ΔTgyl4 represents a lateral aberration amount of the 7-tenths lower ray of the g-line at the 4-tenths image height position,
ΔTgyu8 represents a lateral aberration amount of the 7-tenths upper ray of the g-line at an 8-tenths image height position, ΔTgyl8 represents a lateral aberration amount of the 7-tenths lower ray of the g-line at the 8-tenths image height position, and p represents a pixel pitch of an image sensor used for the image capturing to acquire the input image.

11. An image pickup apparatus comprising:
an image capturer configured to perform image capturing using a zoom lens; and
an image processing apparatus,
wherein the image processing apparatus comprises:
an image acquirer configured to acquire an input image produced by image capturing through a zoom lens whose magnification is variable; and
a processor configured to perform an image restoration process using an image restoration filter produced on a basis of information on aberration of the zoom lens,
wherein the processor is configured to not perform the image restoration process on a central image area of the input image produced by the image capturing through the zoom lens set in a specific magnification state and to perform the image restoration process on a specific image area more outer than the central image area of that input image.

12. A non-transitory storage medium storing an image processing program to cause a computer to perform a process on an input image produced by image capturing through a zoom lens whose magnification is variable,
the process comprising:
acquiring the input image; and
performing an image restoration process using an image restoration filter produced on a basis of information on aberration of the zoom lens,
wherein the process does not perform the image restoration process on a central image area of the input image produced by the image capturing through the zoom lens set in a specific magnification state and performs the image restoration process on a specific image area more outer than the central image area of that input image.

13. An image processing method comprising:
acquiring an input image; and
performing an image restoration process using an image restoration filter produced on a basis of information on aberration of the zoom lens,
wherein the method does not perform the image restoration process on a central image area of the input image produced by the image capturing through the zoom lens set in a specific magnification state and performs the image restoration process on a specific image area more outer than the central image area of that input image.
